(19) United States
(12) Patent Application Publication
(10) Pub. No.: US 2016/0164760 A1
(43) Pub. Date: Jun. 9, 2016

(54) SYSTEM AND METHOD FOR MEASURING TRANSMISSION TIME DIFFERENCE OF SIGNALS TRANSMITTED THROUGH DIFFERENT ROUTES

(71) Applicant: FUJITSU LIMITED, Kawasaki-shi (JP)

(72) Inventors: Naohiro WAKABAYASHI, Kawasaki (JP); DANASIRI WIJEDASA DEWAGAMAGE, Yokohama (JP); Eiji Sugawara, Yokohama (JP)

(73) Assignee: FUJITSU LIMITED, Kawasaki-shi (JP)

(21) Appl. No.: 14/939,298

(22) Filed: Nov. 12, 2015

(30) Foreign Application Priority Data
Dec. 4, 2014 (JP) 2014-245938

(51) Int. Cl. H04L 12/26; H04L 12/727; H04L 12/707

(52) U.S. Cl. CPC H04L 43/0864; H04L 45/22; H04L 45/121

(57) ABSTRACT

A first route and a second route different from the first route are established between first and second nodes in a transmission system including a measuring unit and a computation unit. The measuring unit measures a first signal-transmission time indicating a time taken for a signal to be transmitted in a route starting from the first node and returning to the first node after passing through the first route, the second node, and the second route, and a second signal-transmission time indicating a time taken for a signal to be transmitted in a round-trip route of one of the first and second routes. The computation unit calculates, based on a measurement result of the measuring unit, a transmission time difference indicating a difference between transmission times of a signal transmitted through the first route and a signal transmitted through the second route in a transmission direction of the first signal.

### CROSS-REFERENCE TO RELATED APPLICATION

This application is based upon and claims the benefit of priority of the prior Japanese Patent Application No. 2014-245938, filed on Dec. 4, 2014, the entire contents of which are incorporated herein by reference.

### FIELD

The embodiments discussed herein are related to system and method for measuring transmission time difference of signals transmitted through different routes.

### BACKGROUND

In a communication network such as an optical communication network, a redundant route may be established to improve failure resistance of the communication. For example, there is known a network in which two different communication routes, namely, active and standby routes are established between two transmission devices (or may be referred to as “nodes”), and when a communication failure occurs in the active route, communication of the active route is relieved by the standby route.

Related techniques are disclosed in, for example, Japanese Laid-open Patent Publication Nos. 7-193560 and 2003-218892.

### SUMMARY

According to an aspect of the invention, a transmission system includes a measuring unit and a computation unit, and a first route and a second route different from the first route are established between a first node and a second node in the transmission system. The measuring unit is configured to measure a first signal-transmission time indicating a time that is taken for a signal to be transmitted in a route starting from the first node and returning to the first node after passing through the first route, the second node, and the second route, and a second signal-transmission time indicating a time that is taken for a signal to be transmitted in a round-trip route of one of the first and second routes. The computation unit is configured to calculate, based on a measurement result of the measuring unit, a transmission time difference indicating a difference between transmission times of a signal transmitted through the first route and a signal transmitted through the second route in a transmission direction of the first signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an optical transmission system, according to an embodiment;

FIG. 2 is a diagram illustrating an example of a format of an optional transport network (OTN) frame overhead (OTN OH);

FIG. 3 is a schematic diagram illustrating an example of a “two-way delay measurement processing” in an optical transmission system, according to an embodiment;

FIG. 4 is a schematic diagram illustrating an example of a “ring round-trip delay measurement processing” in an optical transmission system, according to an embodiment;

FIG. 5 is a diagram illustrating an example of a configuration of a transmission node and a reception node, according to an embodiment;

FIG. 6 is a diagram illustrating an example of a configuration of a relay node, according to an embodiment;

FIG. 7 is a diagram illustrating an example of a configuration of an operation system (OPS), according to an embodiment;

FIG. 8 is a diagram illustrating an example of a signal format transmitted and received between nodes and an OPS, according to an embodiment;

FIG. 9 is a diagram illustrating an example of an operational flowchart for delay measurement processing in an optical transmission system, according to an embodiment;

FIG. 10 is a schematic diagram illustrating an example of an internal signal transfer path of a transmission node related to delay measurement processing in an optical transmission system, according to an embodiment;

FIG. 11 is a schematic diagram illustrating an example of an internal signal transfer path of a reception node related to “two-way delay measurement processing” in an optical transmission system, according to an embodiment;

FIG. 12 is a schematic diagram illustrating an example of an internal signal transfer path of a reception node related to “ring round-trip delay measurement processing” in an optical transmission system, according to an embodiment;

FIG. 13 is a diagram illustrating an example of an operational flowchart for an internal operation of a transmission node related to delay measurement processing in an optical transmission system, according to an embodiment;

FIG. 14 is a diagram illustrating an example of an operational flowchart for an internal operation of a reception node related to delay measurement processing in an optical transmission system, according to an embodiment;

FIG. 15 is a diagram illustrating an example of a configuration of a transmission node, according to an embodiment;

FIG. 16 is a diagram illustrating an example of a configuration of a reception node, according to an embodiment; and

FIG. 17 is a diagram illustrating an example of a configuration of a relay node, according to an embodiment.

### DESCRIPTION OF EMBODIMENTS

Switching of the communication from an active route to a standby route may be achieved in a minimum time by transmitting the same signal from a transmission node to the redundant routes and matching the timings of the signals arriving at a reception node via the respective routes.

In order to match the timings of signals arriving at the reception node, transmission times (may be referred to as “delay times”) in the active route and the standby route are measured by sending signals through the respective routes in some cases.

However, the conventional technique is only capable of measuring a round-trip (two-way) transmission delay time for each route between the transmission node and the reception node. Therefore, the conventional technique is not capable of measuring a difference between uni-directional (one-way) delay times accurately.

Hereinafter, embodiments of the disclosed techniques are described with reference to the accompanying drawings. However, embodiments described below are merely illustrative, and not intended to exclude application of various modifications and techniques not specified below. Various illustrative modes described below may be embodied in combination as appropriate. Throughout drawings used for description of the following embodiments, a portion assigned with the same reference numeral represents the same or similar component, unless otherwise indicated.

### First Embodiment

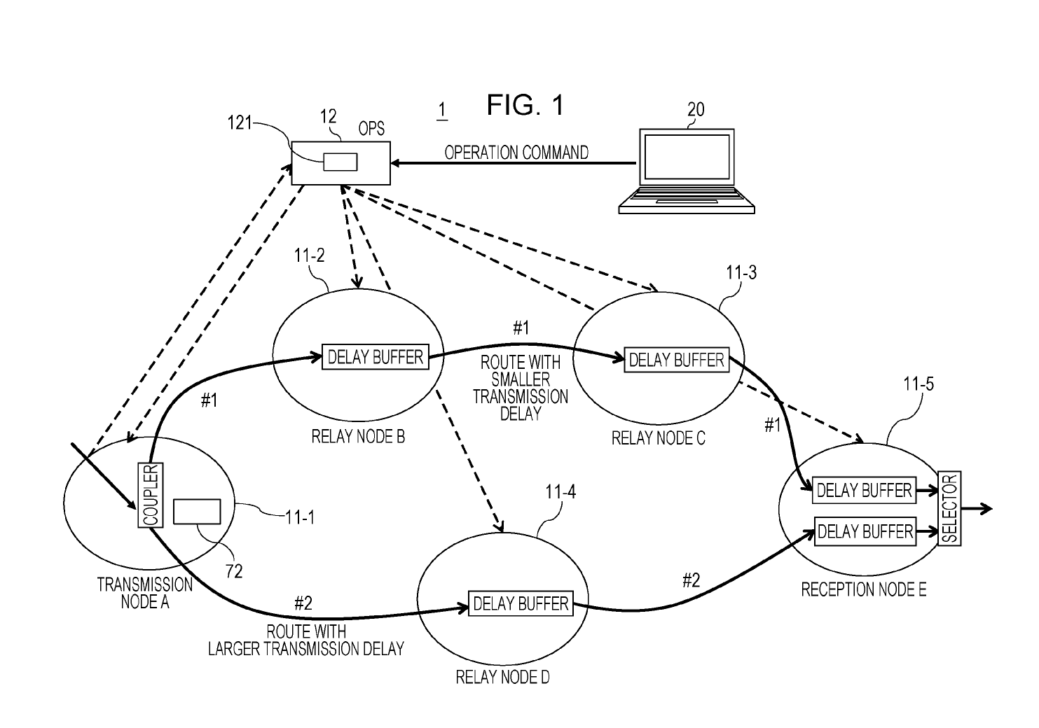

FIG. 1 is a block diagram illustrating a configuration example of an optical transmission system according to the first embodiment. An optical transmission system 1 illustrated in FIG. 1 includes, by way of example, N units of optical transmission devices 11-1 to 11-N, and an operation system (OPS) 12. N is an integer equal to or greater than 2. In the example of FIG. 1, N is 5. The optical transmission system 1 may be referred to as an “optical network 1”, or merely as a “network 1”.

The “optical transmission device” may be referred to as a “node”, a “station”, or a “network element (NE)”. In the example of FIG. 1, optical transmission devices 11-1 to 11-5 are represented as “nodes A to E”, respectively. When nodes 11-1 to 11-5 do not have to be distinguished, each node may be referred to as a “node 11”.

As illustrated in FIG. 1, the nodes A to E may be coupled with one another in a ring shape via an optical transmission path (for example, an optical fiber). In this case, the optical network 1 may be referred to as a “ring network 1”. The nodes A to E are examples of the NE 11 forming the ring network 1.

However, the nodes A to E may be coupled with one another in a mesh shape via an optical transmission path. In this case, the optical network 1 may be referred to as a “mesh network 1”. Further, the embodiment may be applied not only to the ring network and the mesh network, but also to a network of a mode (may be referred to as a “topology”) in which a signal is able to reach between certain specific nodes 11 via multiple different routes.

As illustrated in FIG. 1, the optical network 1 may be provided with a first route #1 extending from the node A to the node E via the nodes B and C, and a second route #2 extending from the node A to the node E via the node D. The route #1 and the route #2 are an example of multiple routes in which a light signal is able to reach from the node A to the node E via different routes.

One of the first route #1 and the second route #2 may be set as an “active” route and the other may be set as a “standby” route. When the active route is disabled due to a fault occurrence or the like, communication of the active route may be relieved by the standby route.

Each of the routes #1 and #2 may be provided with a path (or may be referred to as a “connection”). A path established in the active route #1 (or #2) may be referred to as an “active path”, and a path established in the standby route #2 (or #1) may be referred to as a “standby path”. “Active” and “standby” may be referred to as “working” and “protection”, respectively.

In the following description, for the sake of convenience, a path established in the route #1 may be referred to as a “path #1”, and a path established in the route #2 may be referred to as a “path #2”.

The node A may transmit the same light signal to each of the path #1 and the path #2. For example, a light signal transmitted to the paths #1 and #2 may be a light signal branched from a light signal which the node A has received from another node 11. Branching of the light signal may be implemented, by way of example, by an optical coupler (or an optical splitter).

The node A may be referred to as a “transmission node A” of multiple different routes #1 and #2 (paths #1 and #2). The transmission node A is an example of a first node. A “light signal” transmitted in the optical network 1 may be referred to merely as a “signal”.

The node B may transmit (or “relay”) a light signal of the path #1 received from the transmission node A to the node C. The node C may relay a light signal of the path #1 received from the node B to the node D. Therefore, the nodes B and C may be referred to as a “relay node B” and a “relay node C” of the path #1, respectively.

The node D may relay a light signal of the path #2 received from the transmission node A to the node E. Therefore, the node D may be referred to as a “relay node D” of the path #2. For both of the paths #1 and #2, the number of relay nodes is not limited to the numbers illustrated in FIG. 1.

For example, the path #1 between the transmission node A and the reception node E may be routed through three or more relay nodes 11, or may be routed through only one relay node 11. Depending on the light signal transmission distance, the relay node 11 may not have to be provided in the path #1.

The same applies to the path #2. For example, the path #2 may be routed through two or more relay nodes 11, and depending on the light signal transmission distance, the relay node 11 may not have to be provided in the path #2.

When the transmission node A transmits the same signal to each of the path #1 and the path #2, the node E receives the same signal through each of the different multiple routes #1 and #2 (paths #1 and #2). Therefore, the node E may be referred to as a “reception node E” of the different multiple routes #1 and #2 (paths #1 and #2). The reception node E is an example of a second node.

In the normal operation, the reception node E selects a signal received from a path (by way of example, the path #1) established as an active path out of the paths #1 and #2. When a fault such as a failure occurs in the active path #1, the reception node E selects a signal received from the other optical path (by way of example, the path #2) established as a standby path. The signal selection may be implemented, by way of example, by a selector.

Thus, in response to failure detection in one path #1, the reception node E may switch the path in a minimum delay time by selecting a signal from the other path #2. Path switching in the minimum delay time may be referred to as “uninterruptible switching”.

To enable “uninterruptible switching”, the reception node E may be provided with a delay buffer for adjusting a delay time difference between signals received from the different paths #1 and #2. The delay buffer is an example of the storage unit or memory, and is a functional name of the storage unit or memory.

The “delay time difference” of each signal may be referred to, for example, as a “reception timing difference” or a “phase difference” of each signal when the reception node E receives signals through different routes, or may be referred to as a “arrival time difference” of each signal to the reception node E.

The delay buffer may be provided in each of the different paths #1 and #2 separately. With such a configuration, buffer time of the received signal in each delay buffer may be adjusted individually, and thereby the phase difference between signals received through the different paths #1 and #2 may be reduced to a minimum.

In other words, the reception node E may phase-synchronize signals received through the different paths #1 and #2 by the delay buffers.

Although the example of FIG. 1 illustrates the routes #1 and #2 focusing on the communication from the transmission node #A to the reception node E, communication in the backward direction may be possible in each of the routes #1 and #2.

In other words, the routes #1 and #2 may be used for a unidirectional communication and a bidirectional communication. In the bidirectional communication, the reception node E may be provided with the same function as the transmission node A, and the transmission node A may be provided with the same function as the reception node E.

A signal transmitted in the optical network 1 may be a frame signal, which may be a multiframe signal. By way of example, the signal transmitted in the optical network 1 may be a frame signal compatible with the optical transport network (OTN) transmission system. The frame signal compatible with the OTN transmission system may be referred to, for the sake of convenience, as an “OTN frame” or an “OTN signal”.

The delay buffer may be provided not only in the reception node E, but also in any of the relay nodes B, C, and D. For example, a delay difference between reception signals through the paths #1 and #2 may not be absorbed by a maximum delay amount of a delay buffer provided in the reception node E. In such a case, delay adjustment of the signal may be implemented by any delay buffer of the relay nodes B, C, and D.

For example, assume that, as compared with the path #1, the path #2 has a significant transmission delay which may not be absorbed solely by a delay buffer of the reception node E. In this case, a delay buffer of either or both of the relay nodes B and C may be additionally used to adjust the delay amount of the signal in the optical path #1 in a distributed manner. The relay node D of the path #2 may transmit the signal to the reception node E by bypassing the delay buffer (in other words, without implementing the delay adjustment).

The delay amount (may be referred to as a “buffer delay amount”) by a delay buffer in each of the nodes B to E may be, by way of example, controlled by the OPS 12. The OPS 12 is an example of a system capable of controlling and managing overall operation of the optical network 1. The “OPS” may be referred to as a “network management system (NMS)”.

By way of example, the OPS 12 is capable of receiving a control signal such as the operation command from a terminal 20 (may be referred to as an “operator terminal”) used by an operator such as the network administrator.

As illustrated by dotted arrows in FIG. 1, in response to a control signal received from the operator terminal 20, the OPS 12 is capable of individually controlling the nodes A to E which are NEs of the optical network 1. Communication related to the control between the OPS 12 and the node 11 may be referred to, for the sake of convenience, as “control communication”.

Signals at different transmission rates (may be referred to as “signal rates”) may be hierarchically multiplexed (may be referred to as “mapped”) in the aforesaid OTN frame. The signal mapped in the OTN frame is referred to as an optical channel data unit (ODUk) signal.

“k” of the ODUk signal represents a level (may be alternatively referred to as an “order” or a “layer”) depending on a difference of the signal rate, and ITU-T Recommendation G.709 specifies six types of k including 1, 2, 3, 4, 5, and 6. ITU-T is an abbreviation for “International Telecommunication Union Telecommunication Standardization Sector”.

When the value of “k” does not have to be distinguished, the ODUk signal may be referred to merely as an “ODU signal” by omitting “k”. When another ODU signal is further mapped on the ODU signal, the former “another ODU signal” may be referred to as a “low order (or a low speed) ODU signal (LO-ODU signal)”. Meanwhile, the latter ODU signal on which the LO-ODU signal is mapped may be referred to as a “high order (or a high speed) ODU signal (HO-ODU signal)”.

The ODU signal is an example of the client signal (may be referred to as a “tributary signal”), on which frame signals such as a frame signal of Ethernet (registered trademark) and a frame signal of SDH or SONET may be mapped. “SDH” is an abbreviation for “Synchronous Digital Hierarchy”, and “SONET” is an abbreviation for “Synchronous Optical Network”. SDH and SONET are synchronous digital transmission systems compatible with each other.

The OTN is capable of transmitting a client signal of various protocols and signal rates, such as signals of Ethernet and SDH/SONET, by hierarchically mapping to a signal of higher speed (may be referred to as “encapsulation”).

Therefore, various client signals may be transmitted by the OTN frame between different networks in a transparent manner without being conscious of a difference in protocol and signal rate among client signals.

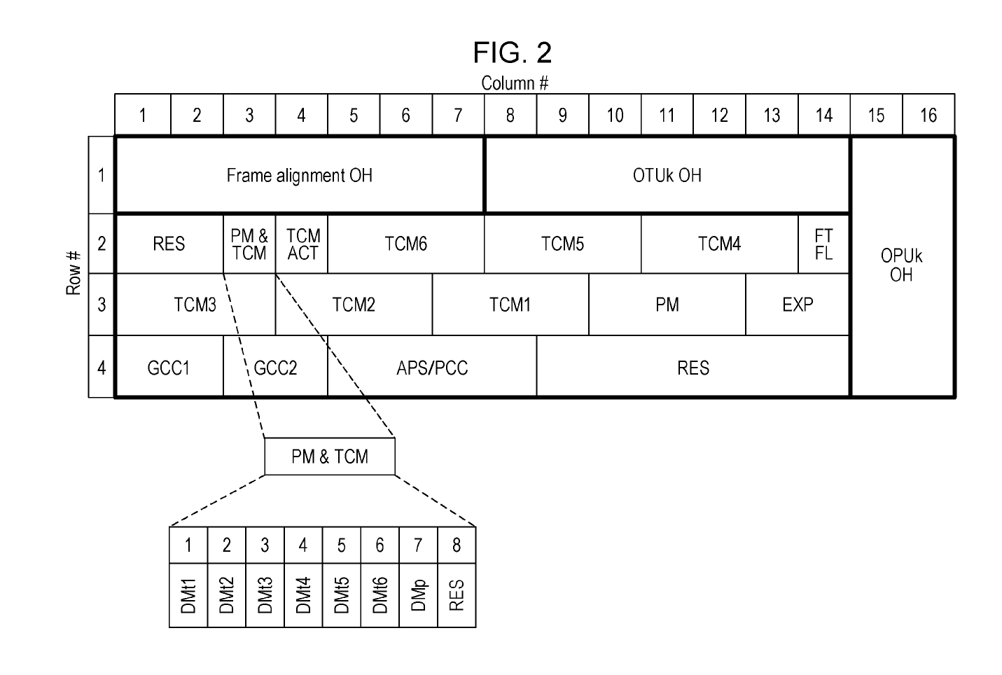

FIG. 2 illustrates a format example of the OTN frame overhead (OTN OH). The OH of the OTN frame has, by way of example, a size of 4 rows×16 columns. The size of one “column” is, for example, 1 byte (8 bits). Information set in the OH may be referred to as “OH information”.

A frame alignment (FA) OH is set in 1st to 7th columns of the first row, and an OH (OTUk OH) of the optical channel transfer unit (OTUk) is set in 8th to 14th columns of the first row.

OH (ODUk OH) of the ODUk signal is set in 1st to 14th columns of 2nd to 4th rows, and an OH (OPUk OH) of the optical channel payload unit (OPUk) signal is set in 15th to 16th columns of 1st to 4th rows.

FAOH contains signals such as the frame alignment signal (FAS) used for frame synchronization of the OTN frame, and the multiframe alignment signal (MFAS) used for identification of the signal position in the multiframe.

OH of each of the OTUk signal and ODUk signal contains information related to monitor, management, and operation of the optical channel according to its own signal level. OH of the OPUk signal contains, for example, information indicating a mapping position (by way of example, a separated field called a tributary slot (TS)) of the client signal onto a payload of the OPUk signal.

OH of the ODUk signal is provided with “PM&TCM”, “TCM ACT”, “TCM”, “PM”, “EXP”, “GCC”, “APS/PCC”, and “RES” fields.

“PM” is an abbreviation for “Path Monitoring”, and “TCM” is an abbreviation for “Tandem Connection Monitoring”. 1st to 6th bits of the “PM&TCM” field are referred to as “DMt (ODUk TCM delay measurement) 1 to 6”, respectively.

Each of the “DMt 1 to 6” corresponds to a segment (or section) formed by dividing a path (ODUk path” or “ODUk connection) in which the ODUk signal is transmitted (to maximum six segments). The ODUk path may be considered to correspond to a path #1 or path #2 illustrated in FIG. 1.

By using “DMt 1 to 6”, transmission delay measurement may be implemented in the ODUk path for each of maximum six segments. In other words, information related to delay measurement for each segment in the ODUk path may be set in the corresponding one of “DMt 1 to 6”.

The 7th bit of the “PM&TCM” field is referred to as “DMp (ODUk PM Delay Measurement), and may be used for the transmission delay measurement of any ODUk path established in the optical network 1. The 8th bit of the “PM&TCM” field is a reserve (RES) bit reserved for future standardization.

Also, reserve fields (RES) provided in 1st to 2nd columns (2 bytes) of the second row and 9th to 14th columns (6 bytes) of the fourth row of “ODUk OH” illustrated in FIG. 2 are fields reserved for future standardization. Normally, all of the reserve fields (or reserve bits) are set at “0”.

“TCM” of the “TCM ACT” field (1 byte) is an abbreviation for “Tandem Connection Monitoring”, and “ACT” is an abbreviation for “Activation/deactivation control channel”.

“TCM 1 to 6” fields (3 bytes for each) are provided to enable monitoring of the fault occurrence state and the line quality of the ODUk path for each segment. In other words, monitor information may be set in the “TCM 1 to 6” fields for each segment of the ODUk path.

The “PM” field (3 bytes) may be used for monitoring the ODUk path. For example, the trail trace identifier (TTI), the bit interleaved parity (BIP-8), the backward defect indication (BDI), and the backward error indication (BEI) may be set in the “PM” field.

The “EXP” field (2 bytes) is a field provided for an experimental use.

“GCC” is an abbreviation for the general communication channel, and may be used for communication of control information, monitor information, and management information between optical transmission devices (may be referred to as “OTN devices”) 11 compatible with the OTN.

Three kinds (2 bytes for each) of the “GCC” field including “GCC0”, “GCC1”, and “GCC2” are provided. “GCC0” is positioned at 12th to 13th columns out of “OTUk OH” positioned at 8th to 14th columns of the first row in FIG. 2. “GCC1” and “GCC2” are positioned at 1st to 2nd columns and 3rd to 4th columns of the fourth row of “OTN OH”, respectively.

“APS” of the “APS/PCC” field (4 bytes) is an abbreviation for “Automatic Protection Switching”, and “PCC” is an abbreviation for “Protection Communication Control”. Switching control information between the active path and the standby path may be set in the “APS/PCC” field. The “uninterruptible switching” mentioned above may be implemented based on the switching control information.

Meanwhile, in recent years, importance of the transmission delay measurement using the aforesaid “PM&TCM” field has been increasing. For example, with the development of the Ethernet and Internet Protocol (IP) technology in recent years, information of various services has come to be transmitted and received in networks.

An example of the services is a stock market on-line service. In some of stock market on-line services, delay of information transmitted in a network may affect profits of the end user. In other words, transmission delay in the network may be considered as one indicator of the network quality.

In view of the foregoing, the OTN defines a scheme (for example, “PM&TCM” field) for measuring the transmission delay not defined by SDH and SONET, as an information element of “OTN OH” as described above.

In the optical network 1, redundant configuration may be adopted to enhance the failure resistance. In a metropolitan area, a path switch ring (PSR) in which optical transmission devices 11 are connected in a ring shape via optical fiber transmission paths, for example, as illustrated in FIG. 1, may be adopted.

In the PSR, an active path where a failure has occurred may be switched to a standby path of another route (may be referred to as a “redundant path”) in an uninterruptible manner as described above. Therefore, even when a failure has occurred in the active path, service may be continued by using a standby path.

As described above, “uninterruptible switching” of the path is implemented by minimizing the phase difference between signals received from the active path and the standby path by the delay buffer in the reception node 11.

The phase difference between a signal received from the active path and a signal received from the standby path may be calculated, for example, by measuring the transmission delay difference between the active path and the standby path using path OH information of a frame (or a multiframe) transmitted from the active path and the standby path. In this case, however, a measurable maximum delay difference may be limited by the cycle of the frame signal or multiframe signal into which OH information is inserted.

(delay Measurement (DM) Processing)

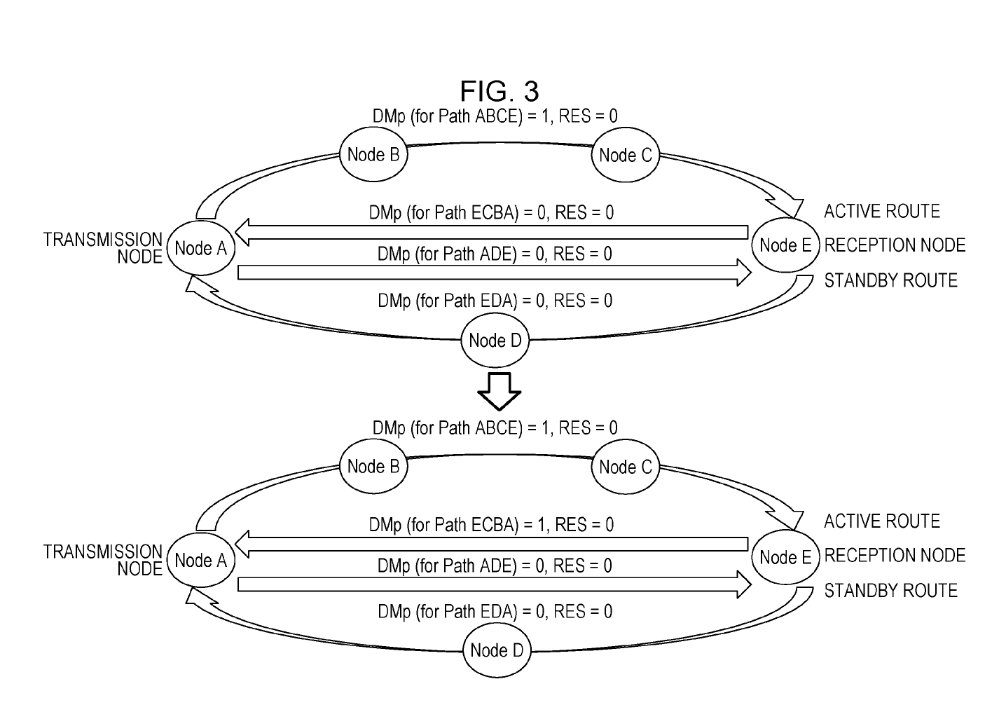

An example of the delay measurement (DM) using the “PM&TCM” field described with reference to FIG. 2 is described with reference to FIG. 3. FIG. 3 schematically illustrates an overview of the normal DM processing.

In the example of FIG. 3, a route passing through the nodes B and C between the node A and the node E is established as the active route #1, and a route passing through the node D between the node A and the node E is established as the standby route #2.

In the active route #1, by way of example, a path (ABCE) directed from the transmission node A to the reception node E (may be referred to as “in the forward direction”), and a backward path (ECBA) are established.

In the standby route #2, by way of example, a path (ADE) in the forward direction from the transmission node A to the reception node E, and a backward path (EDA) are established.

In the normal operation, the “DMp” bit, which is a seventh bit of the “PM&TCM” field, is set at “0” for any of the path “ABCE”, the path “ECBA”, the path “ADE”, and the path “EDA”. The “RES” bit, which is an eighth bit of the “PM&TCM” field, is also set at the default value of “0” for any of the paths in the normal operation.

For example, when the transmission node A implements transmission delay measurement for a forward path “ABCE” of the active route #1, the transmission node A changes the DMp bit of a signal to be transmitted to the path “ABCE” from “0” to “1”, as illustrated in an upper diagram of FIG. 3.

Upon detecting that the DMp bit of the signal received from the path “ABCE” is set at “1”, the reception node E sets (or changes) the DMp bit of a signal to be transmitted to a backward path “ECBA” of the same active route #1 at “1”, as illustrated in a lower diagram of FIG. 3.

This processing may be considered to correspond to mapping (or “overwriting”) of a DMp bit received from the forward path “ABCE” onto a DMp bit to be transmitted to the backward path “ECBA”.

The transmission node A, which constantly receives a signal of the backward path “ECBA” from the reception node E, may detect a timing when the DMp bit of the reception signal of the backward path “ECBA” is changed to “1”.

Therefore, the transmission node A may measure a time (delay time) for two-way travel of the signal in the active route #1, based on a timing when a change of the DMp bit is detected, and a timing when the DMp bit of transmission signal to the forward path “ABCE” is changed to “1”. Also, a two-way delay time in the standby route #2 may be measured in the same manner.

Here, the delay time which is able to be measured by using the DMp bit as above is just a two-way delay time, but not a uni-directional (one-way) delay time. As a one-way delay time, for example, a merely half value of the measured two-way delay time may be calculated.

However, it is difficult to say that the half value of the measured two-way delay time indicates an accurate one-way delay time, since the half value is just an estimation value based on the measurement value. For this reason, even if a two-way delay time is measured for each of the active route and the standby route, a one-way delay time difference between the two routes obtained based on the measurement result may be a value with a large error and low reliability.

Under the present circumstance in which transmission delay of the network is regarded as one indicator of the network quality as mentioned above, it is not preferable that such error may exist. For example, if delay adjustment is implemented by the aforesaid delay buffer based on the one-way delay time difference with a large error, “uninterruptible switching” may not be achieved.

The one-way delay time difference between multiple routes may be measured accurately if timing information such as the time stamp is assigned to a signal used for the delay measurement. However, a measurement error occurs unless all of NEs involved in the delay measurement are time-synchronized with high accuracy.

For this reason, a highly accurate clock signal source has to be provided in the NEs, or a mechanism for time-synchronizing the NEs has to be provided separately. As a result, costs of the NE may increase, and thereby costs of the network may increase.

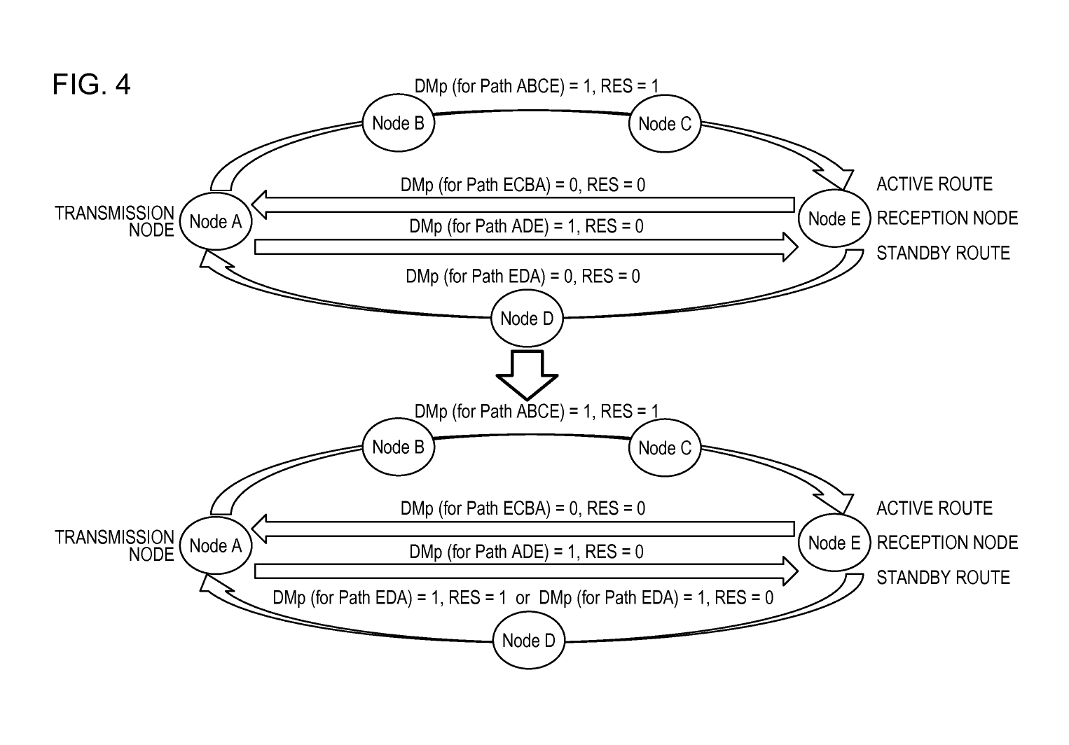

In view of the foregoing problems, this embodiment provides a method of accurately measuring the one-way delay time difference of multiple routes in a simplified manner. For example, the “normal DM processing” illustrated in FIG. 3 is used in combination with the “ring round-trip DM processing” illustrated in FIG. 4. Thus, for example, the one-way delay time difference in the Unidirectional PSR (UPSR) may be measured accurately. The “normal DM processing” may be referred to as a “two-way DM processing”.

Hereinafter, the “ring round-trip DM processing” illustrated in FIG. 4 is described. In FIG. 4, when implementing the “ring round-trip DM processing”, the transmission node A of the UPSR sets information (may be referred to as “flag information”) indicating its intention to a signal transmitted to a target path of the DM processing.

As a non-limiting example, the RES bit of the “PM&TCM” field may be used for the flag information. For example, since the default value of the RES bit is “0” as described above, “1” may be set to indicate the “ring round-trip DM processing”.

For example, as illustrated in the upper diagram of FIG. 4, when measuring the one-way delay time difference in the direction from the transmission node A to the reception node E, the transmission node A sets the RES bit of the “PM&TCM” field in a signal transmitted to the forward path “ABCE” at “1”.

At the same time, the transmission node A sets the DMp bit of the “PM&TCM” field in a signal transmitted to the forward path “ADE” of the standby route #2 at “1”. With the DMp bit set to “1”, the reception node E operates in the same manner as in the “two-way DM processing” illustrated in FIG. 3. In other words, the “ring round-trip DM processing” and the “two-way DM processing” may be implemented in parallel.

By referring to the “PM&TCM” field” of the signal received from the path “ABCE” of the active route #1, the reception node E may detect that the RES bit is set at “1”.

In response to the detection, the reception node E sets at “1” the RES bit in the “PM&TCM” field of the transmission signal to the standby route #2, which is different from the active route #1 and in which the signal is able to reach the transmission node A.

For example, in FIG. 4, the reception node E sets at “1” the RES bit in the “PM&TCM” field of a signal transmitted to the backward path “EDA” of the standby route #2. The processing may be considered to correspond to mapping or overwriting of OH information of a signal received from the active route #1 onto a signal to be transmitted in the backward direction in the standby route #2 paired with the active route #1.

At the same time, upon detecting that the DMp bit in the “PM&TCM” field of the signal received from the forward path “ADE” of the standby route #2 is set at “1”, the reception node E may set the DMp bit of the signal transmitted to the backward path “EDA” of the standby route #2 at “1” as the “two-way DM processing”.

Therefore, the transmission node A may receive a signal indicating the “ring round-trip DM processing” and a signal indicating the “two-way DM processing” from the backward path “EDA” of the standby route #2.

By receiving the signal indicating the “ring round-trip DM processing”, the transmission node A may measure a delay time DM (R) corresponding to ring round-trip starting from the transmission node A.

Also, by receiving a signal indicating the “two-way DM processing” for the standby route #2, the transmission node A may measure a two-way delay time DM(N) of the standby route #2 as described with reference to FIG. 3.

For example, the transmission node A may measure delay times DM (R) and DM(N) represented by the following two formulas (1) and (2).

DM(R)=W(A->E)+P(E->A) (1)

DM(N)=P(A->E)+P(E->A) (2)

In the formula (1), W(A->E) represents a delay time that elapses until a signal transmitted from the node A in the active route #1 reaches the node E. P(A->E) represents a delay time that elapses until a signal transmitted from the node E in the standby route #2 reaches the node A.

Meanwhile, in the formula (2), P(A->E) represents a delay time that elapses until a signal transmitted from the node A in the standby route #2 reaches the node E. P(A->E) represents a delay time that elapses until a signal transmitted from the node E in the standby route #2 reaches the node A.

The following formula (3) may be obtained by subtracting the formula (2) from the formula (1):

DM(R)−DM(N)=W(A->E)−P(A->E) (3)

A difference between DM(R) and DM(N) represented by the formula (3) corresponds to a delay time difference in the forward direction (one-way) from the node A to the node E between a signal transmitted in the active route #1 and a signal transmitted in the standby route #2.

Thus, one-way delay time difference between the active route #1 and the standby route #2 may be determined as a measurement value, but not an estimation value. Arithmetic operation of the formula (3) may be implemented by the OPS 12 or by the transmission node A. An example implemented by the transmission node A corresponds to a second embodiment described later.

As described above, changing the DMp bit and/or the RES bit of the “PM&TCM” field in “ODUk OH” corresponds to changing the OH information corresponding to the active route #1 (active path #1) or the standby route #2 (standby path #2).

A signal that the transmission node A transmits to the active route #1 by changing the OH information corresponding to the active route #1 will be also expressed as a first signal. A signal that the transmission node A transmits to the standby route #2 by changing the OH information corresponding to the standby route #2 will be also expressed as a third signal. The transmission node A may include a transmission unit capable of transmitting the first signal and the third signal.

Meanwhile, the reception node E may include a receiving unit that receives the first signal having the changed OH information from the active route #1, and the third signal having the changed OH information from the standby route #2.

A signal that the reception node E transmits to the standby route #2 by changing the OH information corresponding to the standby route #2 in response to reception of the first signal from the active route #1 will be also expressed as a second signal. A signal that the reception node E transmits to the standby route #2 by changing the OH information corresponding to the standby route #2 in response to reception of the third signal from the standby route #2 will be also expressed as a fourth signal. The reception node E may include a transmission unit capable of transmitting the second signal and the fourth signal.

The transmission node A measures a transmission timing of the first signal, a reception timing of the second signal, a transmission timing of the third signal, and a reception timing of the fourth signal. For this reason, the transmission node A may include a measuring unit configured to measure these timings. The measuring unit may store the above timings into a storage unit such as a memory, a storage device, or a storage medium.

A transmission timing of the first signal in the transmission node A corresponds, for example, to a timing when a transmission unit of the transmission node A changes OH information corresponding to the active route #1 of the first signal.

A transmission timing of the third signal in the transmission node A corresponds, for example, to a timing when a transmission unit of the transmission node A changes OH information corresponding to the standby route #2 of the third signal.

A transmission timing of the first signal and transmission timing of the third signal may be identical or different.

A reception timing of the second signal in the transmission node A corresponds to a timing when a change of the OH information of the second signal, caused by a transmission unit of the reception node E changing OH information corresponding to the standby route #2 of the second signal, is detected by the transmission node A.

A reception timing of the fourth signal in the transmission node A corresponds to a timing when a change of the OH information of the fourth signal, caused by a transmission unit of the reception node E changing OH information corresponding to the standby route #2 of the fourth signal, is detected by the transmission node A.

The timing when the reception node E changes OH information corresponding to the standby route #2 of the second signal, and the timing when the reception node E changes OH information corresponding to the standby route #2 of the fourth signal may be the same or different from each other.

The above formula (3) may be considered to represent a subtraction of a difference between the transmission timing of the third signal and the reception timing of the fourth signal, from a difference between the transmission timing of the first signal and the reception timing of the second signal.

A “computation unit” performing arithmetic operation represented by the formula (3) may be provided in any of the OPS 12, the transmission node A, or the NE 11 of the optical network 1.

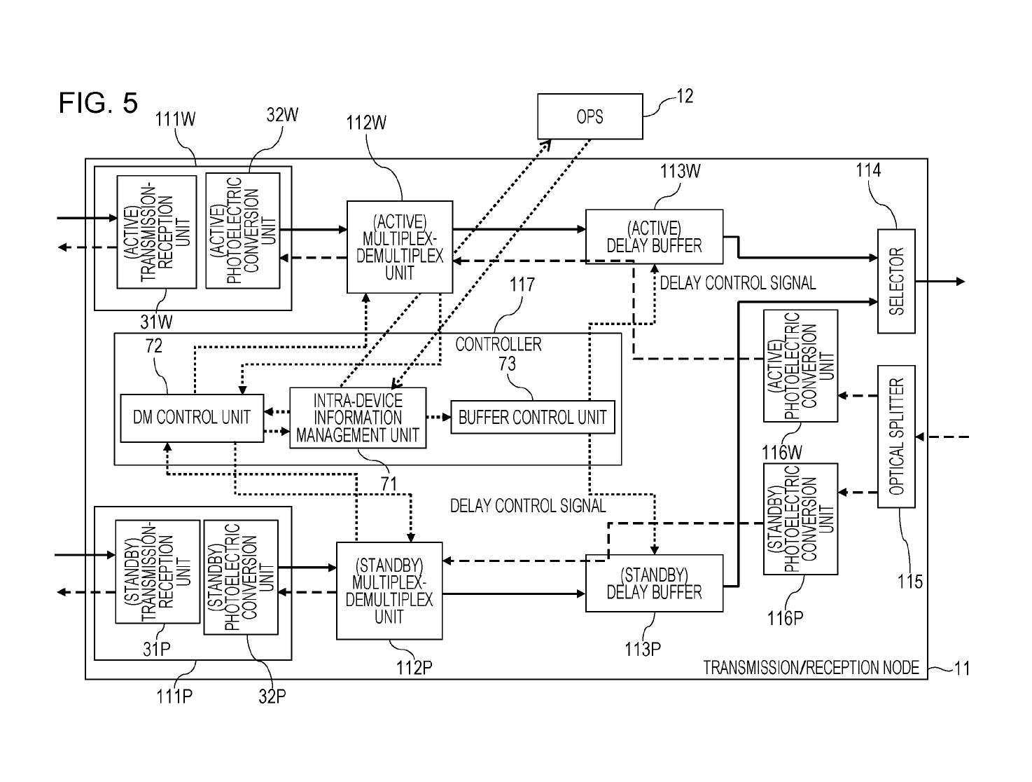

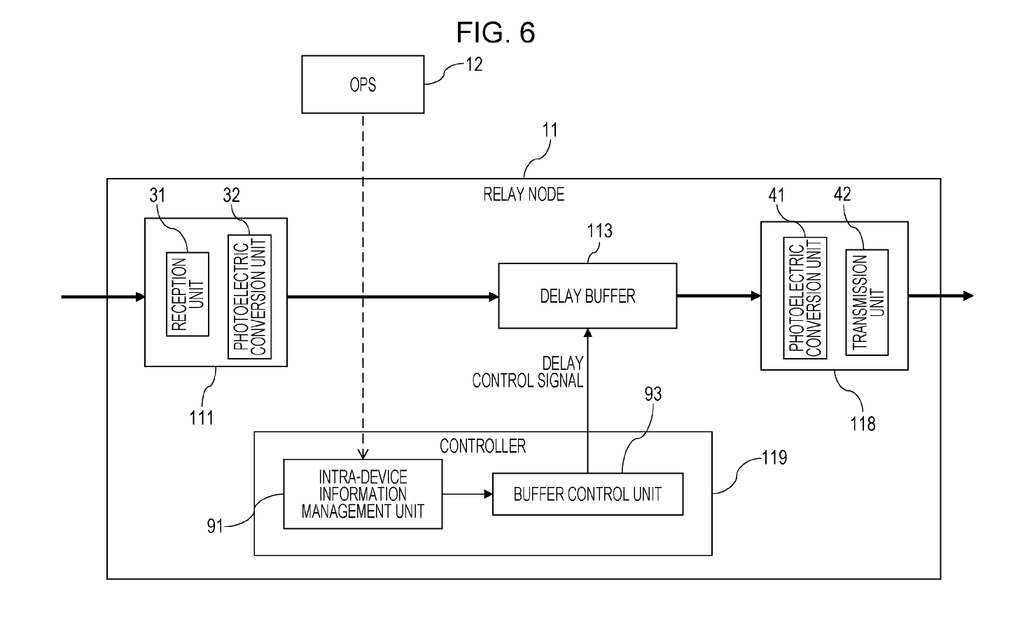

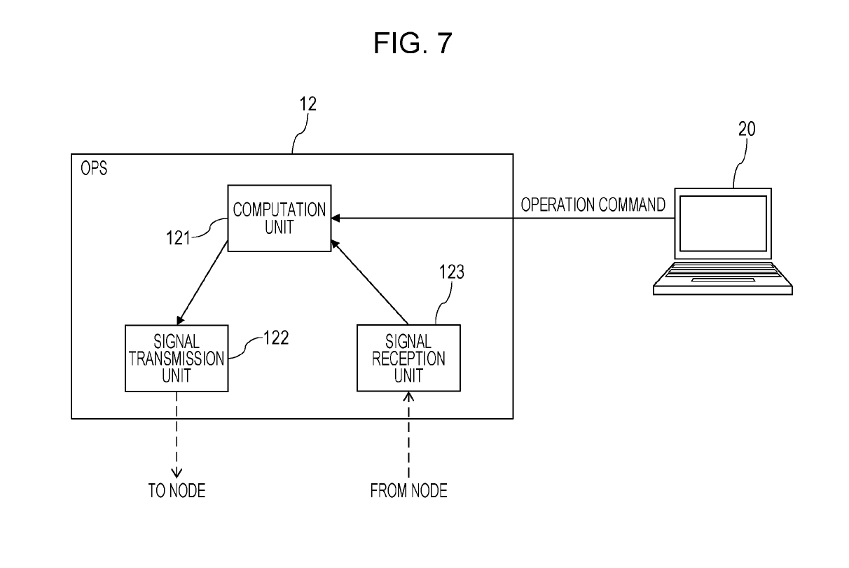

Next, a configuration example of the node 11 and OPS 12 implementing the aforesaid one-way delay time difference measurement is described with reference to FIGS. 5 to 7. FIG. 5 is a block diagram illustrating a configuration example of the transmission node 11 and the reception node 11. FIG. 6 is a block diagram illustrating a configuration example of the relay node 11. FIG. 7 is a block diagram illustrating a configuration example of the OPS 12.

(Configuration Example of Transmission Node and Reception Node)

Configuration of the node 11 illustrated in FIG. 5 may be considered to correspond to the configuration example of the transmission node A and the reception node E illustrated in FIG. 1.

As illustrated in FIG. 5, the node 11 includes, by way of example, an optical transceiver 111W, a multiplex-demultiplex unit 112W, and a delay buffer 113W, which operate for the active route. The node 11 includes, by way of example, an optical transceiver 111P, a multiplex-demultiplex unit 112P, and a delay buffer 113P, which operate for the standby route.

Further, the node 11 includes, by way of example, a selector 114, an optical splitter 115, a photoelectric conversion unit (O/E)116W for the active route, a photoelectric conversion unit (O/E) 116P for the standby route, and a controller 117.

The optical transceiver 111W converts a light signal received from the active route to an electric signal, and outputs the electric signal to the active multiplex-demultiplex unit 112W. Also, the optical transceiver 111W converts the electric signal received from the active multiplex-demultiplex unit 112W to a light signal, and transmits the light signal to the active route.

For this reason, the optical transceiver 111W may include, by way of example, a transmission-reception unit 31W and a photoelectric conversion unit (O/E) 32W.

The transmission-reception unit 31W receives the light signal from the active route and outputs the light signal to the photoelectric conversion unit 32W. Also, the transmission-reception unit 31W transmits the light signal received from the photoelectric conversion unit 32W to the active route.

The photoelectric conversion unit 32W converts the received light signal outputted from the transmission-reception unit 31W to an electric signal, and outputs the electric signal to the active multiplex-demultiplex unit 112W. Also, the photoelectric conversion unit 32W converts the electric light received from the active multiplex-demultiplex unit 112W to a light signal, and outputs the light signal to the transmission-reception unit 31W.

The active multiplex-demultiplex unit 112W separates the received signal converted to the electric signal by the photoelectric conversion unit 32W of the active optical transceiver 111W to, for example, multiple path signals multiplexed on the received signal. Also, the active multiplex-demultiplex unit 112W multiplexes multiple path signals received from the active delay buffer 113W, and outputs the multiplexed multiple path signals to the optical transceiver 111W (photoelectric conversion unit 32W).

In the path signal multiplexing processing by the multiplex-demultiplex unit 112W, OH information including the aforesaid “PM&TCM” field may be assigned (mapped) to the multiplexed signal. The OH information may be assigned, by way of example, to the multiplex-demultiplex unit 112W by the controller 117.

In the path signal separation processing by the multiplex-demultiplex unit 112W, OH information including the aforesaid “PM&TCM” field may be extracted. The extracted OH information may be given to the controller 117.

The active delay buffer 113W temporarily buffers a path signal received from the active multiplex-demultiplex unit 112W, and adjusts a timing (in other words, delay time or buffer time) of outputting the path signal to the selector 114.

Also, the delay buffer 113W temporarily buffers a backward path signal received from the active photoelectric conversion unit 116W, and adjusts a timing of outputting the path signal to the multiplex-demultiplex unit 112W.

The delay time (delay amount) in the delay buffer 113W may be controlled, by way of example, by the controller 117 (for example, a buffer control unit 73 of the controller 117, which is described later). The delay amount may be “0”. The same may apply to a delay amount in a standby delay buffer 113P.

The optical transceiver 111P, the multiplex-demultiplex unit 112P, and the delay buffer 113P, which are provided for the standby route, may operate on signals of the standby route in the same manner as the active optical transceiver 111W, multiplex-demultiplex unit 112W, and delay buffer 113W, respectively.

The selector 114 selectively outputs either one of the path signals outputted from the active delay buffer 113W and the standby delay buffer 113P. The selector 114 is provided in the “reception node 11” of the active path and the standby path to enable aforesaid “interruptible switching”.

The optical splitter 115 branches and outputs the received light signal to the active photoelectric conversion unit 116W and the standby photoelectric conversion unit 116P. The optical splitter 115 is provided in the “transmission node 11” of each of the active path and the standby path to enable transmission of the identical signal to both of the active path and the standby path.

The active photoelectric conversion unit 116W converts the branched light signal received from the optical splitter 115 to an electric signal, and outputs the electric signal to the active delay buffer 113W. The signal corresponds to a signal that the node 11 as the “transmission node 11” transmits to the active path.

The standby photoelectric conversion unit 116P converts the branched light signal received from the optical splitter 115 to an electric signal, and outputs the electric signal to the standby delay buffer 113P. The signal corresponds to a signal that the node 11 as the “transmission node 11” transmits to the standby path.

The delay amount generated by each of the delay buffers 113W and 113P for signals that the node 11 as the “transmission node 11” transmits to the active path and the standby path may be “0”.

Assuming that the configuration illustrated in FIG. 5 is the configuration of the transmission node A, the active multiplex-demultiplex unit 112W and optical transceiver 111W may be considered to correspond to a transmission unit that transmits, as the transmission node A, the aforesaid first signal to the active route #1.

The standby multiplex-demultiplex unit 112P and optical transceiver 111P may be considered to correspond to a transmission unit that transmits, as the transmission node A, the aforesaid third signal to the standby route #2.

Meanwhile, assuming that the configuration illustrated in FIG. 5 is the configuration of the reception node E, the active optical transceiver 111W and multiplex-demultiplex unit 112W may be considered to correspond to a first receiving unit that receives, as the reception node E, the first signal from the active route #1.

The standby optical transceiver 111P and multiplex-demultiplex unit 112P may be considered to correspond to a receiving unit that receives, as the reception node E, the third signal from the standby route #2.

The standby optical transceiver 111P and multiplex-demultiplex unit 112P may be considered to also correspond to a transmission unit that transmits, as the reception node E, the second signal to the standby route #2 in response to reception of the first signal from the active route #1.

Further, the active optical transceiver 111W and multiplex-demultiplex unit 112W may be considered to also correspond to a transmission unit that transmits, as the reception node E, the fourth signal to the standby route #2 in response to reception of the second signal from the standby route #2.

The controller 117 controls the entire operation of the node 11. The control may include, by way of example, setting of the OH information, control of transmission delay measurement using the “PM&TCM” field of the OH information, control of the delay amount in delay buffers 113W and 113P, and so on.

For this reason, the controller 117 may include, by way of example, an intra-device information management unit 71, a delay measurement (DM) control unit 72, and a buffer control unit 73.

The intra-device information management unit 71 manages, by way of example, information transmitted and received in the control communication between the node 11 and the OPS 12. The information may include control information such as instructions and directions received from the OPS 12 and information related to responses and reports transmitted to the OPS 12.

By way of example, control information received from the OPS 12 may include the DM implementation instruction, and information transmitted to the OPS 12 may include information indicating the DM result.

The intra-device information management unit 71 may cause the DM control unit 72 to implement DM in response to reception of the DM implementation instruction. The intra-device information management unit 71 may report the DM result to the OPS 12 in response to reception of the DM result from the DM control unit 72.

The DM control unit 72 in the transmission node 11 controls setting of the “PM&TCM” field in the OH information multiplexed in the multiplex-demultiplex unit 112W (or 112P) in response to the DM implementation instruction from the intra-device information management unit 71. For this reason, the DM control unit 72 may be also referred to as an “OH control unit 72”.

For example, in response to the “two-way DM processing” implementation instruction, the DM control unit 72 sets the DMp bit of the “PM&TCM” field at “1” as described above. Also, in response to the “ring round-trip DM processing” implementation instruction, the DM control unit 72 sets the RES bit of the “PM&TCM” field at “1”.

The DM control unit 72 in the transmission node 11 may measure a path delay time based on a timing when a setting is changed, with reference to setting of the “PM&TCM” field in the OH information extracted by the multiplex-demultiplex unit 112W (or 112P). The measurement result may be given to the intra-device information management unit 71. The DM control unit 72 may be considered to be an example of the measuring unit, and comprise a function as the measuring unit.

The DM control unit 72 in the reception node 11 may determine whether any one of “normal” and “ring round-trip” DM processing has been started, with reference to setting of the “PM&TCM” field in the OH information extracted by the multiplex-demultiplex unit 112W (or 112P).

By way of example, in response to control communication from the OPS 12 via the intra-device information management unit 71, the buffer control unit 73 controls a delay amount in active and standby delay buffers 113W and 113P.

As described above, when the signal delay is controlled by multiple nodes 11 in a distributed manner, the delay amount may be, by way of example, a buffer delay amount borne by each node 11, which is determined by the OPS 12. The buffer delay amount borne by each node 11 may be referred to as a “delay distribution amount”. The route related to the setting of the “distributed delay amount” may be referred to as a “delay distribution route”.

(Configuration Example of Relay Node)

Next, a configuration example of the relay node 11 is described with reference to FIG. 6. The configuration of the relay node 11 illustrated in FIG. 6 may be considered to correspond to the configuration of the relay nodes B, C, and D illustrated in FIG. 1.

The relay node 11 illustrated in FIG. 6 includes, by way of example, an optical receiver 111, a delay buffer 113, an optical transmitter 118, and a controller 119.

The optical receiver 111 causes a receiving unit 31 to receive a light signal transmitted from the transmission node 11 or another relay node 11, causes the photoelectric conversion unit (O/E) 32 to convert the received light signal to an electric signal, and outputs the electric signal to the delay buffer 113.

The delay buffer 113 temporarily buffers a signal received from the optical receiver 111 (photoelectric conversion unit 32), and adjusts a timing of outputting the signal to the optical transmitter 118. The delay amount in the delay buffer 113 may be controlled, by way of example, by the controller 119 (for example, a buffer control unit 93 provided in the controller 119, as described later). The delay amount may be “0”.

The optical transmitter 118 causes the photoelectric conversion unit (O/E) 41 to convert a signal received from the delay buffer 113 to a light signal, and transmits the light signal to an optical transmission path in a direction from the transmission unit 42 to the reception node 11.

The configuration illustrated in FIG. 6 is a configuration focused on the uni-directional communication. When supporting a backward communication (in other words, the bidirectional communication), the relay node 11 may be provided with an optical receiver 111, a delay buffer 113, and an optical transmitter 118, which are the same as those mentioned above, for the backward communication.

The controller 119 controls the entire operation of the relay node 11. The control may include control of the signal delay amount by the delay buffer 113 in response to the control communication from the OPS 12.

For this reason, the controller 119 may include, by way of example, an intra-device information management unit 91, and a buffer control unit 93. The intra-device information management unit 91 is, by way of example, capable of performing the control communication with the OPS 12.

By way of example, in response to the control communication from the OPS 12 via the intra-device information management unit 91, the buffer control unit 93 controls a delay amount in the active and standby delay buffers 113W and 113P. As described above, when the signal delay is controlled by multiple nodes 11 in a distributed manner, the delay amount may be, by way of example, a buffer delay amount borne by each node 11, which is determined by the OPS 12.

(Configuration Example of OPS)

Next, a configuration example of the OPS 12 is described with reference to FIG. 7. An OPS 12 illustrated in FIG. 7 includes, by way of example, a computation unit 121, a signal transmission unit 122, and a signal reception unit 123.

In response to reception of control information such as an operation command from the operator terminal 20, the computation unit 121, by way of example, generates control information addressed to the node 11 or processes information received from the node 11.

Control information generated by the computation unit 121 may include the DM implementation instruction for the transmission node 11, the buffer delay amount for any of the nodes 11, and so on. Information received from the node 11 may include the DM measurement result that the transmission node 11 reports to the OPS 12.

Based on the DM measurement result, the computation unit 121 may calculate the one-way delay time difference by the formula (3). Also, based on the calculated one-way delay time difference, the computation unit 121 may determine how much buffer delay amount is to be assigned to each node 11.

The computation unit 121 may be formed of a processor having arithmetic capability, such as a central processing unit (CPU) and a digital signal processor (DSP). The “processor” may be referred to as a processor device or a processor circuit.

The signal transmission unit 122 transmits, by way of example, a signal including control information generated by the computation unit 121 to a target node 11.

The signal reception unit 123 receives, by way of example, a signal including information such as the DM measurement result transmitted by any of the nodes 11.

The signal transmission unit 122 and the signal reception unit 123 may be integrally configured as a signal transmission-reception unit. The computation unit 121 may be coupled with a storage unit such as a memory, a storage device, or a storage medium drive via a communication bus, and so on. The computation unit 121 implements the operation and function as the OPS 12 by reading a program and data stored in a memory or the like and executing the program.

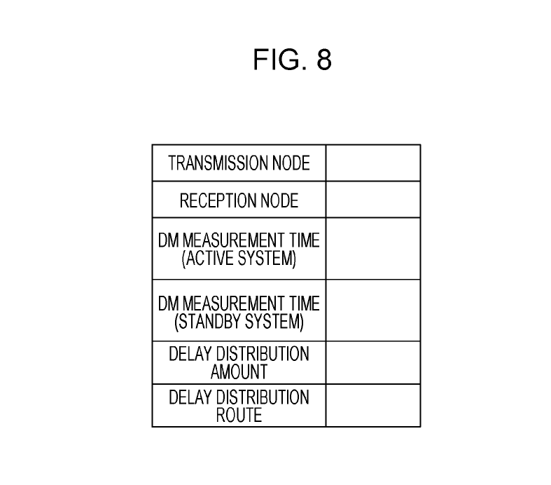

A signal format such as illustrated in FIG. 8 may be used for the control communication between the OPS 12 and the node 11. Information by which the transmission node 11 and the reception node 11 are identifiable individually, and information by which the DM measurement time being the DM measurement result, the delay distribution amount, and the delay distribution route are identifiable may be set in the signal format illustrated in FIG. 8, as appropriate.

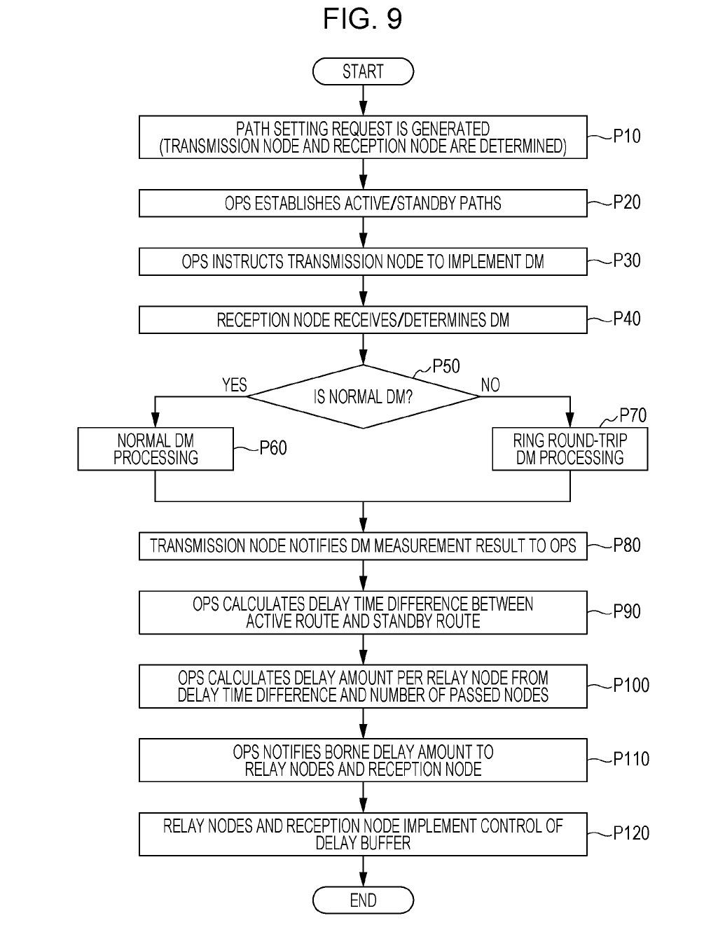

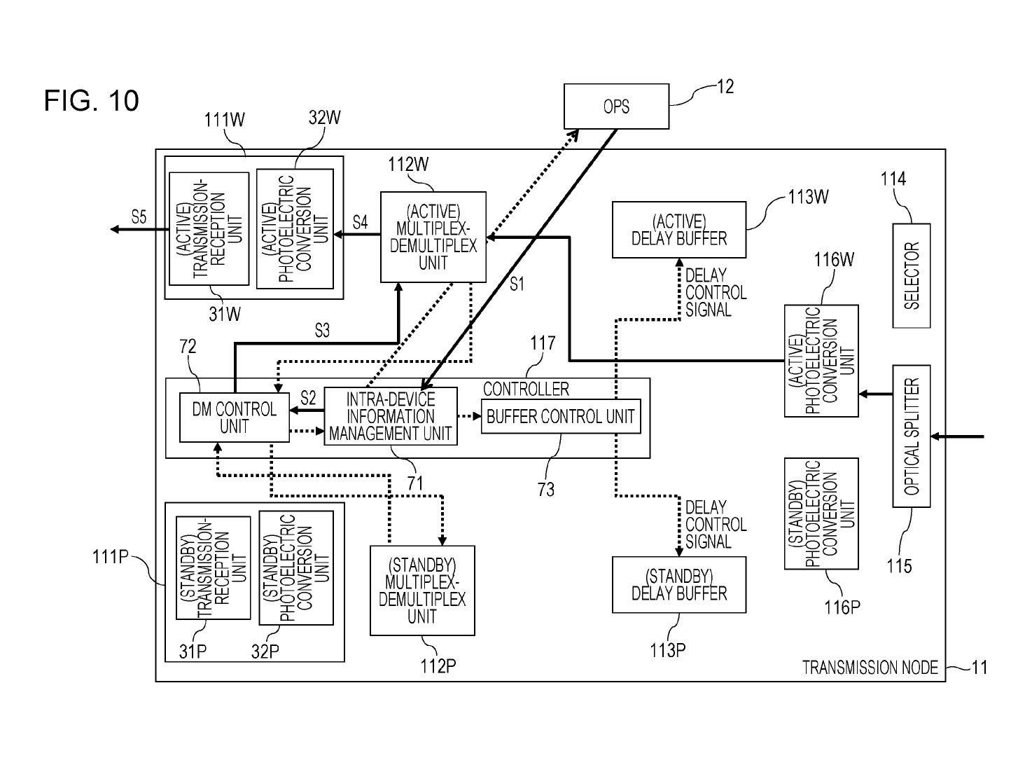

Hereinafter, an example of the operation related to the DM processing in the optical transmission system 1 configured as above is described with reference to FIGS. 9 to 14. FIG. 9 is a flowchart illustrating an example of the operation related to the DM processing in the optical transmission system 1 as a whole. FIG. 10 schematically illustrates an internal signal transfer path of the transmission node 11 for illustrating the operation in the transmission node 11 related to the DM processing.

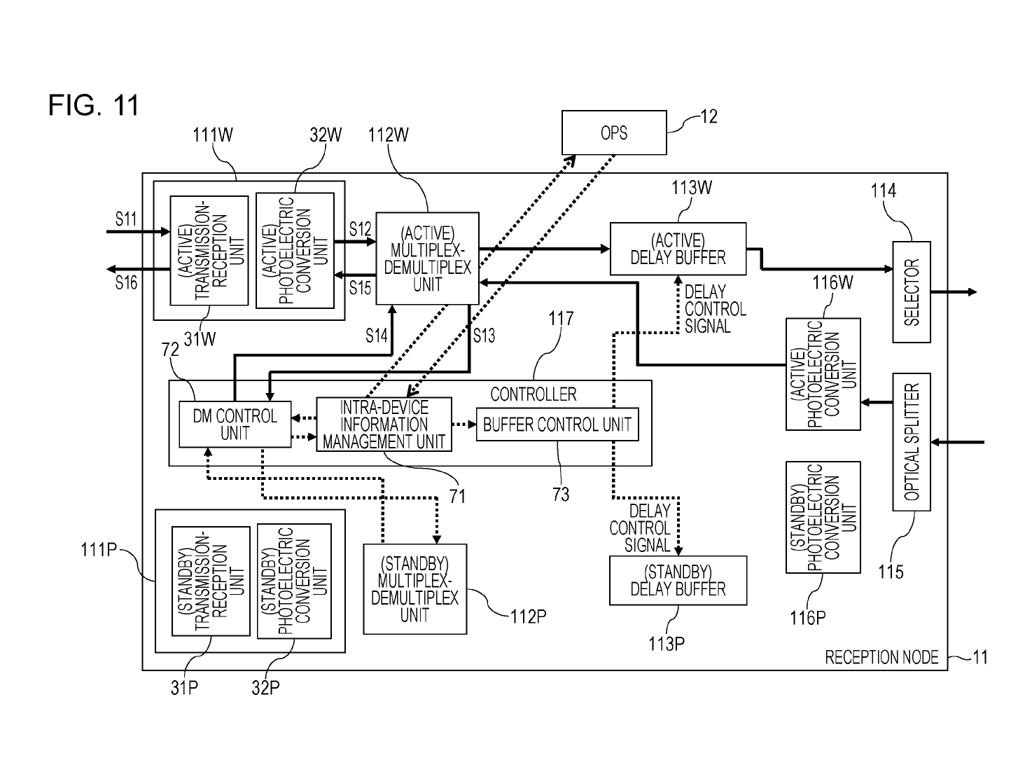

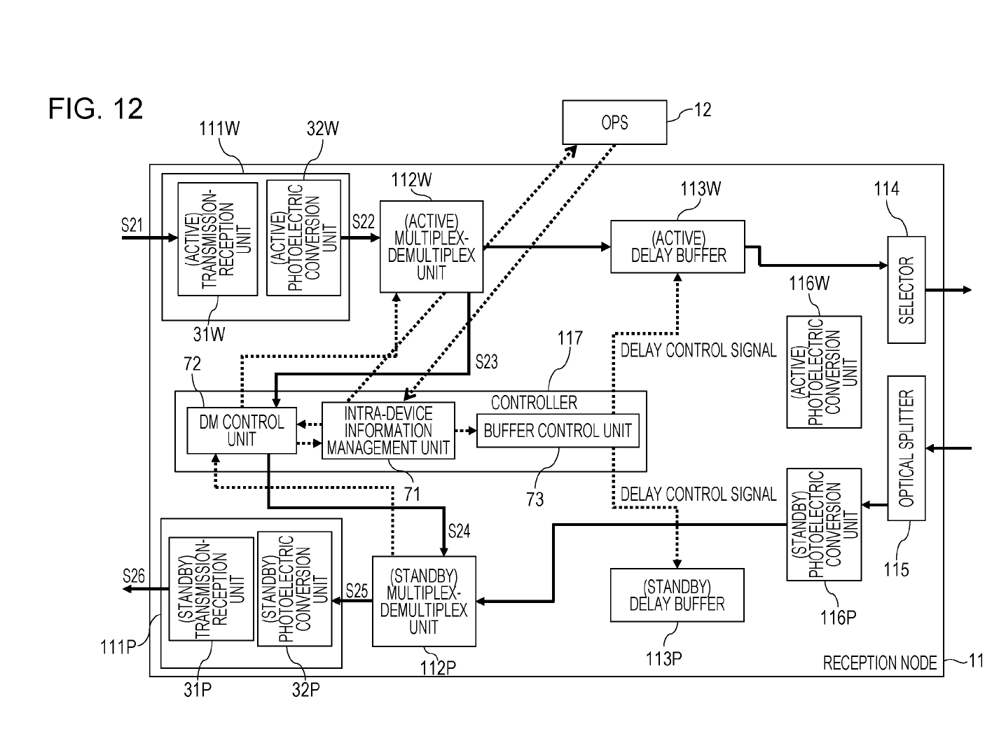

FIG. 11 schematically illustrates an internal signal transfer path of the reception node 11 for illustrating the operation in the reception node 11 related to the “two-way DM processing”, and FIG. 12 schematically illustrates an internal signal transfer path of the reception node 11 for illustrating the operation in the reception node 11 related to the “ring round-trip DM processing”.

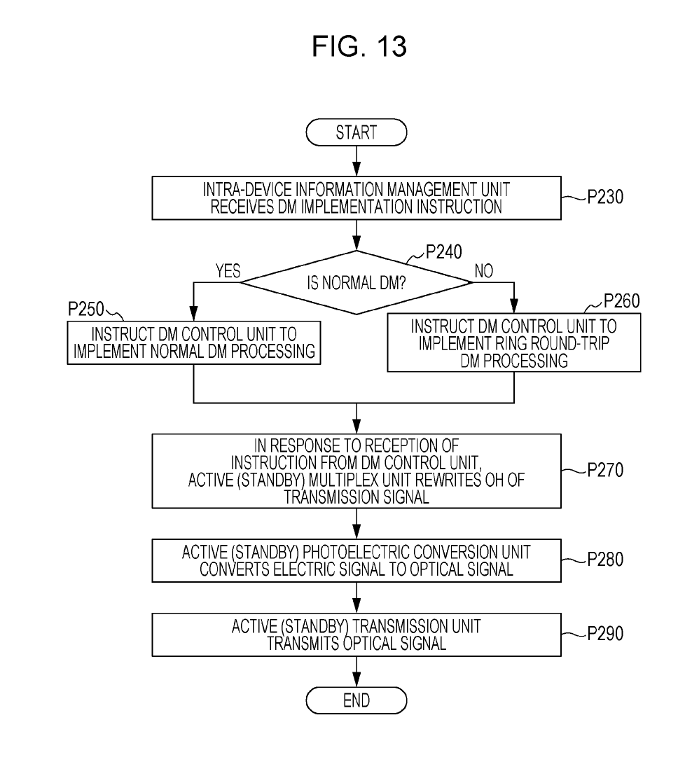

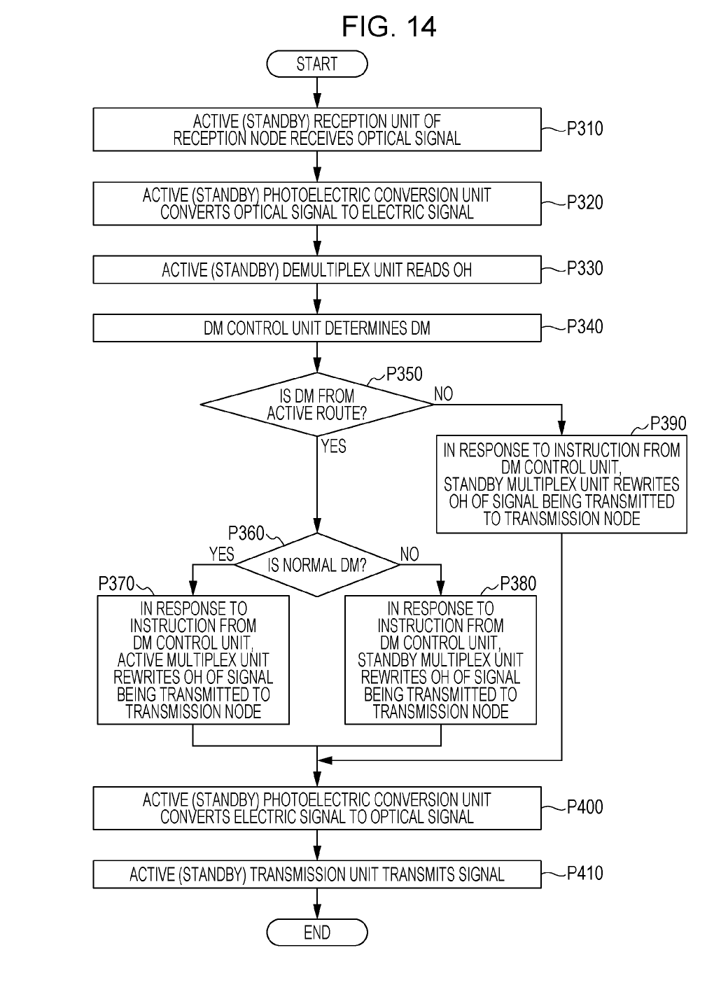

FIG. 13 is a flowchart illustrating an example of the internal operation of the transmission node 11 related to the DM processing, and FIG. 14 is a flowchart illustrating an example of the internal operation of the reception node 11 related to the DM processing.

In the flowchart of FIG. 9, a path setting request is received by the OPS 12 (computation unit 121) in the step P10. The path setting request is, by way of example, given by the operator terminal 20.

The network administrator determines two optional nodes 11 in the optical network 1 of the management target as the “transmission node” and the “reception node” by using an input interface supported by the operator terminal 20. Hereinafter, assume that the node A has been determined as the “transmission node”, and the node E has been determined as the “reception node”, as illustrated in FIG. 1.

The operator terminal 20 may support graphical user interface (GUI) or command line interface (CLI) as an example of the input interface.

In the step P20, the OPS 12 implements setting of the active path and the standby path. For example, the OPS 12 implements setting of the active path and the standby path to the transmission node A and the reception node E in response to a path setting request received from the operator terminal 20.

Determination of the active path and the standby path is implemented by the computation unit 121. For example, as illustrated in FIG. 1, assume that setting of the active path #1 as the active route #1 and setting of the standby path #2 as the standby route #2 has been determined.

In response to the determination of the active path #1 and standby path #2, the OPS 12 sets identification information of the transmission node A and the reception node E to the signal format illustrated in FIG. 8, and transmits the signal from the signal transmission unit 122 (see FIG. 7) to all the nodes A to E, which the paths #1 and #2 pass through.

After setting the active path #1 and the standby path #2, the OPS 12 transmits the DM implementation (start) instruction to the transmission node A in the step P30. The DM implementation instruction may include information indicating which of the “two-way DM processing” and the “ring round-trip DM processing” to implement.

The DM implementation instruction is received by the controller 117 (for example, intra-device information management unit 71) (see FIG. 5) of the transmission node A. Referring to the internal operation of the transmission node A, reception of the DM implementation instruction is represented, for example, by a solid line arrow S1 of FIG. 10, and corresponds to the step P230 of FIG. 13.

Upon receiving the DM implementation instruction, the intra-device information management unit 71 determines whether the instruction is an implementation instruction of the “two-way DM processing” or the “ring round-trip DM processing”. The determination processing corresponds, for example, to the step P240 of FIG. 13.

When the determination result is the implementation instruction of the “two-way DM processing” (step P240: YES), the intra-device information management unit 71 gives the “two-way DM processing” implementation instruction to the DM control unit 72.

Meanwhile, when the determination result is the implementation instruction of the “ring round-trip DM processing” (steps P50 and P240: NO), the intra-device information management unit 71 gives the “ring one-round DM processing” implementation instruction to the DM control unit 72.

Referring to the internal operation of the transmission node A, these processes of the intra-device information management unit 71 giving a DM implementation instruction to the DM control unit 72 are represented, for example, by a solid line arrow S2 of FIG. 10, and correspond to steps P250 and P260 of FIG. 13.

In the “two-way DM processing”, the DM control unit 72 implements rewriting of “ODUk OH” of a signal flowing in the active route #1 (standby route #2) from the transmission node A to the reception node E in the multiplex-demultiplex unit 112W (112P).

For example, in response to control from the DM control unit 72, the multiplex-demultiplex unit 112W (112P) changes the DMp bit in the “PM&TCM” field of a signal flowing in the forward direction toward the reception node E in the active route #1 or the standby route #2 from “0” to “1”.

Meanwhile, in the “ring round-trip DM processing”, the DM control unit 72 changes the RES bit of the “PM&TCM” field from “0” to “1” in addition to the change in the “two-way DM processing”.

For example, the DM control unit 72 changes the RES bit in the “PM&TCM” field of a signal flowing toward the reception node E in the active route #1 (multiplex-demultiplex unit 112W) from “0” to “1”.

Referring to the internal operation of the transmission node A, the aforesaid rewriting of the OH information is represented, for example, by a solid line arrow S3 of FIG. 10.

In other words, the DM control unit 72 may implement the “two-way DM processing” for the standby route #2, and the “ring round-trip DM processing” for the active route #1.

A light signal transmitted to each of the optical transmission paths of the active route #1 and the standby route #2 is generated by the optical splitter 115 (see FIG. 5). The light signals branched by the optical splitter 115 are converted to an electric signal by the active photoelectric conversion unit 116W and the standby photoelectric conversion unit 116P, respectively.

The electric signals converted from the light signals are sent to the active multiplex-demultiplex unit 112W and the standby multiplex-demultiplex unit 112P, respectively. In the path signal multiplexing at the multiplex-demultiplex units 112W and 112P, the aforesaid rewriting of OH information of the DM target path is implemented by the DM control unit 72 (step P270 of FIG. 13).

In the multiplex-demultiplex unit 112W (112P), the electric signal on which multiple path signals including a DM target path are multiplexed is converted to a light signal by active and standby optical transceivers 111W and 111P, and the light signal is transmitted to the active route #1 (standby route #2). The conversion and transmission processes correspond, for example, to steps P280 and P290 of FIG. 13.

Next, in the step P40 of FIG. 9, the reception node E checks OH information of the received signal, and determines whether to implement the “two-way DM processing” or the “ring round-trip DM processing”.

For example, the reception node E receives light signals from both of the active path #1 and the standby path #2 at the active transmission-reception unit 31W and the standby transmission-reception unit 31P (see FIG. 5). This processing corresponds to the step P310 of FIG. 14. Referring to reception processing of the active path #1, the reception processing is represented, for example, by a solid line arrow S11 of FIG. 11, and a solid line arrow S21 of FIG. 12.

A light signal received by the active (standby) transmission-reception unit 31W (31P) is converted to an electric signal by the active (standby) photoelectric conversion unit 32W (32P) and sent to the multiplex-demultiplex unit 112W (112P). The processing is represented, for example, by a solid line arrow S12 of FIG. 11 and a solid line arrow S22 of FIG. 12, and corresponds to the step P320 of FIG. 14.

The signal converted to an electric signal is separated to multiple path signals by the active (standby) multiplex-demultiplex unit 112W (112P). In the separation processing, the DM control unit 72 of the reception node E reads OH information of the active path #1 and the standby path #2, and checks values of the DMp bit and the RES bit of the “PM&TCM” field. The processing is represented, for example, by a solid line arrow S13 of FIG. 11 and a solid line arrow S23 of FIG. 12, and corresponds to the step P330 of FIG. 14.

In the step P50 of FIG. 9, the DM control unit 72 determines based on the checked DMp bit and the RES bit of the “PM&TCM” field whether the “two-way DM processing” or the “ring round-trip FM processing” is being implemented for the active route #1 by the transmission node A. The processing corresponds, for example, to steps P340 and P350 of FIG. 14.

For example, when the DMp bit in the “PM&TCM” field of the path signal received from the active route #1 is “1”, and the RES bit of the field is “0”, the DM control unit 72 determines that the “two-way DM processing” is being implemented for the active route #1. The processing corresponds, by way of example, to the YES route of the step P50 in FIG. 9, and YES routes of steps P350 and P360 in FIG. 14.

Meanwhile, when the RES bit of the path signal received from the active route #1 is “1”, the DM control unit 72 determines that the “ring round-trip DM processing” is being implemented. The processing corresponds to the NO route of the step P50 in FIG. 9, and the NO route of the step P360 in FIG. 14.

In response to the determination that the “two-way DM processing” is being implemented, the DM control unit 72 of the reception node E rewrites OH information of the signal flowing backward in the path where signal with the DMp bit set at “1” is received (step P60 of FIG. 9).

For example, when the DMp bit of the signal received from the active path #1 is “1”, the DM control unit 72 changes the DMp bit of the “PM&TCM” field in a signal flowing backward in the same active route #1 where the active path #1 is established, from “0” to “1”. The processing corresponds, for example, to a processing represented by the step P370 from the YES route of the step P360 in FIG. 14.

When the DMp bit of the signal received from the standby path #2 is “1”, the DM control unit 72 changes the DMp bit of the “PM&TCM” field in a signal flowing backward in the same standby route #2 where the standby path #2 is established, from “0” to “1”. The processing corresponds, for example, to a processing represented by the step P390 following the NO route of the step P350 in FIG. 14.

The above OH information rewriting processing may be considered to correspond to mapping of the DMp bit received from the active route #1 or the standby route #2 in the forward direction onto the OH information of a signal flowing backward in the same active route #1 or standby route #2. “Mapping” may be referred to as “overwriting”.

The OH information rewriting processing may be considered to correspond to rewriting of the OH information of the target path signal through multiplexing by the multiplex-demultiplex unit 112W (112P) illustrated in FIG. 5. For example, the OH information rewriting processing in the “two-way DM processing” is represented by a solid line arrow S14 of FIG. 11.

Meanwhile, when it is determined that the “ring round-trip DM processing” is implemented, the DM control unit 72 rewrites the OH information of the signal flowing to the transmission node A in a route different from a path in which a signal with the RES bit set at “1” is received. The processing corresponds to a process from the NO route of the step P50 to the step P70 in FIG. 9.

Assuming that the signal with the RES bit set at “1” is a signal of the active path #1, the DM control unit 72 of the reception node E rewrites the OH information of a signal flowing toward the transmission node A in a standby route #2 different from an active route #1 to which the active path #1 is established.

For example, the DM control unit 72 changes each of the DMp bit and the RES bit in the “PM&TCM” field of the signal flowing toward the transmission node A in the standby route #2 from “0” to “1”.

The OH information rewriting processing may be considered to correspond to mapping of the DMp bit and the RES bit received from the active route #1 of the forward direction onto the OH information of a signal flowing backward in a different standby route #2.

The OH information rewriting processing may be considered to correspond to rewriting of the OH information of a target path signal through multiplexing by the standby multiplex-demultiplex unit 112P illustrated in FIG. 5. For example, the OH information rewriting processing is represented by a solid line arrow S24 of FIG. 12, and corresponds to a processing represented by the NO route of the step P360 to the step P380 in FIG. 14.

In response to control of the DM control unit 72, the reception node E may map the DMp bit and the RES bit received from a standby route #2 of the forward direction onto the OH information of a signal flowing backward in a different active route #1.

The signal (electric signal) with the OH information rewritten by the multiplex-demultiplex unit 112W (112P) in the reception node E as above is converted to a light signal by the photoelectric conversion unit 32W (32P) of the optical transceiver 111W (111P). The processing is represented, for example, by a solid line arrow S15 of FIG. 11 (solid line arrow S25 of FIG. 12), and corresponds to the step P400 of FIG. 14.

The light signal obtained by the photoelectric conversion unit 32W (32P) is transmitted to an optical transmission path in a direction from the transmission-reception unit 31W (31P) toward the transmission node A. The processing is represented, for example, by a solid line arrow S16 of FIG. 11 (solid line arrow S26 of FIG. 12), and corresponds to the step P410 of FIG. 14.

Next, in the step P80 of FIG. 9, the transmission node A notifies the DM measurement result to the OPS 12. For example, when the transmission node A implements the “two-way DM processing” for the active route #1 (or standby route #2), the DM control unit 72 measures the DM measurement value DM (N) of the active route #1 (or the standby route #2).

The DM measurement value DM(N) in the “two-way DM processing” may be measured as a difference (T2−T1) between the following timings T1 and T2.

T1: a timing when the DMp bit of a signal flowing from the transmission node A toward the reception node E is changed from “0” to “1”.

T2: a timing when the DMp bit of a signal flowing backward is switched from “0” to “1” in a route same as the route where the DMp bit changed to “1” at the timing of T1 flows.

Meanwhile, when the transmission node A implements the “ring round-trip DM processing”, the DM control unit 72 measures the DM measurement value DM(R) in the “ring round-trip DM processing” in addition to the DM measurement value DM(N) in the “two-way DM processing”.

The DM measurement value DM(R) in the “ring round-trip DM processing” may be measured as a difference (T4−T3) between the following timings T3 and T4.

T3: a timing when the RES bit of a signal flowing from the transmission node A toward the reception node E is changed from “0” to “1”.

T4: a timing when the RES bit of a signal flowing backward is switched from “0” to “1” in a route different from the route in which the RES bit changed to “1” at the timing of T3 flows.

Whether the DM measurement value is DM(R) or DM(N) is determined by the DM control unit 72 by checking the RES bit in the “PM&TCM” field of the target signal.

The DM measurement value obtained by the DM control unit 72 is notified to the intra-device information management unit 71. The intra-device information management unit 71 transmits the notified DM measurement value to the OPS 12 (step P80 of FIG. 9). For example, the intra-device information management unit 71 sets the DM measurement value into the “DM measurement time (active/standby)” field of the signal format illustrated in FIG. 8, and then transmits the signal format to the OPS 12. Therefore, the intra-device information management unit 71 may be considered to be an example of the notification unit that notifies the DM measurement value to the OPS 12.

The DM measurement value DM(R) obtained in the “ring round-trip DM processing” from the active route #1 to the standby route #2 may be set, by way of example, into the “DM measurement time (active) field. The two-way DM measurement value DM(N) obtained for a standby route #2 in the “ring round-trip DM processing” may be set into the “DM measurement time (standby)” field.

Next, in the step P90 of FIG. 9, the OPS 12 calculates a one-way delay time difference for the active route #1 and the standby route #2, based on the DM measurement value received from the transmission node A.

For example, the computation unit 121 of the OPS 12 calculates a difference between the DM measurement value DM(R) and the DM measurement value DM(N) as illustrated in the formula (3), and thereby determines a one-way delay time difference between the active route #1 and the standby route #2.

Next, in the step P100 of FIG. 9, the OPS 12 calculates a buffer delay amount in the relay node 11, based on the one-way delay time difference calculated in the step P90.

For example, the computation unit 121 of the OPS 12 determines a route having a smaller delay time, based on the delay time difference between the active route #1 and the standby route #2. In the example of FIG. 1, the active route #1 is determined to be a route having a smaller delay time.

Then, based on the delay time difference between the active route #1 and the standby route #2, and the number of relay nodes in a route #1 having a smaller delay time, the computation unit 121 calculates a buffer delay amount borne by each of the relay node 11 and the reception node 11 in the route #1 with a smaller delay time.

In the example of FIG. 1, a buffer delay amount borne by each of the relay nodes B and C as well as the reception node E is calculated. The number of relay nodes in the routes #1 and #2 may be considered to be known as topology information or be calculable based on the information by the OPS 12.

Next, in the step P110 of FIG. 9, the OPS 12 notifies the borne buffer delay amount to the relay nodes B and C as well as the reception node E. For example, the computation unit 121 of the OPS 12 may set the buffer delay amount borne by each node 11 into the “delay distribution amount” field of the signal format illustrated in FIG. 8.

In addition, the computation unit 121 may set information indicating the delay distribution route into the “delay distribution route” field of the signal data format illustrated in FIG. 8. For example, “0” may be set to indicate that the delay distribution route is the active route #1, and “1” may be set to indicate that the delay distribution route is the standby route #2.

The OPS 12 notifies the buffer delay amount borne by each of corresponding nodes 11 by transmitting thereto the signal in which the “delay distribution amount” and the “delay distribution route” are set as above.

For example, the relay nodes B and C notify the buffer delay amount to the intra-device information management unit 91 of the controller 119 illustrated in FIG. 6. The reception node E notifies the buffer delay amount to the intra-device information management unit 71 of the controller 117 illustrated in FIG. 5.

Next, in the step P120 of FIG. 9, the node 11, to which the buffer delay amount is notified by the OPS 12, controls the delay amount of the delay buffer to the notified buffer delay amount. For example, in the reception node E, the intra-device information management unit 71 (see FIG. 5) of the controller 117 gives information of the “delay distribution amount” and the “delay distribution route” notified by the OPS 12 to the buffer control unit 73.

In accordance with information given by the intra-device information management unit 71, the buffer control unit 73 controls the delay amount of either or both of the active delay buffer 113W and the standby delay buffer 113P. Whether to control the active delay buffer 113W or the standby delay buffer 113P is identifiable based on information of the “delay distribution route”.

Meanwhile, in the relay nodes B and C, the intra-device information management unit 91 (see FIG. 6) of the control unit 119 gives information of the “delay distribution amount” and the “delay distribution route” notified by the OPS 12 to the buffer control unit 93.

In accordance with information given by the intra-device information management unit 91, the buffer control unit 93 controls the delay amount of the delay buffer 113. When the relay node 11 is provided with a delay buffer 113 in the backward direction from the reception node E to the transmission node A, the delay buffer 113 of the control target may be identified based on information of the “delay distribution route”.

In the relay nodes B and C having the configuration illustrated in FIG. 6, the light signal received by the receiving unit 31 of the optical receiver 111 is converted to an electric signal by the photoelectric conversion unit 32. The signal converted to an electric signal is sent to the delay buffer 113, in which the buffer delay amount is adjusted as described above.

The electric signal outputted from the delay buffer 113 is converted to a light signal by the photoelectric conversion unit 41 of the optical transmitter 118, and transmitted to an optical transmission path in a direction from the transmission unit 42 to the reception node E.

Meanwhile, in the reception node E having the configuration illustrated in FIG. 5, the transmission-reception unit 31W (31P) of the active (standby) optical transceiver 111W (111P) receives the light signal from the optical transmission path of the active route #1 (standby route #2).

The received light signal is converted to an electric signal by the photoelectric conversion unit 32W (32P) and sent to the multiplex-demultiplex unit 112W (112P). The multiplex-demultiplex unit 112W (112P) separates a target path signal from the electric signal received from the photoelectric conversion unit 32W (32P).

Then, the path signal separated by the multiplex-demultiplex unit 112W (112P) is sent to the delay buffer 113W (113P), in which the buffer delay amount is adjusted as above. Signals outputted from the active delay buffer 113W and the standby delay buffer 113P are sent to the selector 114, and one of the signals is selected by the selector 114.

Since the buffer delay amount has been adjusted in the relay nodes B and C as well as the reception node E as above, a signal flowing in the active route #1 and a signal flowing in the standby route #2 are received by the selector 114 of the reception node E at the same timing. Therefore, “uninterruptible switching” may be achieved by switching of the selector 114.

As described above, in the first embodiment, the transmission node A sets flag information to the RES bit of the “PM&TCM” field in the OH information of the ODUk path in a direction toward the reception node E.

Then, based on the flag information, the reception node E determines which of the “two-way DM processing” and the “ring round-trip DM processing” is indicated. When the flag information indicates the “ring round-trip DM processing”, the reception node E determines from which of the active route #1 and the standby route #2 the signal was received.

When the determination result is that the signal indicating the “ring round-trip DM processing” is a signal received from the active route #1, the reception node E maps OH information of the signal received from the active route #1 onto OH information of a signal flowing toward the transmission node A in the standby route #2. The OH information of the mapping target is, by way of example, the DMp bit and the RES bit.

Meanwhile, when the reception signal indicating the “ring round-trip DM processing” is a signal received from the standby route #2, the reception node E maps the OH information of the signal received from the standby route #2 onto the OH information of a signal flowing backward toward the transmission node A in the active route #1.

In the transmission node A, a delay time difference between the active route #1 and the standby route #2 in a one way toward the reception node E may be measured from a difference between a timing when the transmission node A rewrites OH information and a timing when OH information of a signal received from the reception node E is changed.

Therefore, a one-way delay time difference may be measured at a precision higher than when a one-way delay time difference is estimated based on the two-way delay time obtained by “two-way DM processing”.

Thus, for example, information of accurate delay time difference may be provided to the network administrator (operator terminal 20). Consequently, the network administrator is able to efficiently perform network management for setting of active and standby routes (or paths), optimization of the distributed arrangement of delay buffers in the UPSR, and so on.

In the aforesaid “ring round-trip DM processing”, the timing when the transmission node A or the reception node E rewrites OH information is not limited by the frame cycle or multiframe cycle. Therefore, the measurable maximum delay difference is also not limited by the frame cycle or multiframe cycle.

Further, in the above example, time information such as the time stamp does not have to be provided since the one-way delay time difference may be calculated from the difference between DM(R) and DM(N) as illustrated in the formula (3).

Therefore, accurate time synchronization of NEs 11 in the optical network 1 does not have to be established, and for the transmission delay measurement, an accurate clock signal source in the NEs 11 and a scheme for establishing accurate time synchronization between NEs 11 do not have to be provided.

In other words, the aforesaid “ring round-trip DM processing” may be easily introduced into an existing network. Consequently, this allows avoidance or suppression of cost increase of the NE and network for the transmission delay measurement.

### Second Embodiment

The above first embodiment is described by citing an example in which the OPS 12 calculates a one-way delay time difference in the UPSR, and controls the buffer delay time of each node 11, based on the delay time difference.

The second embodiment is described by citing an example in which in place of the OPS 12, any one of nodes 11 forming the UPSR calculates the one-way delay time difference and controls the buffer delay time in an autonomous distributed manner.

As illustrated in FIG. 2, OH information of the ODUk path includes a general communication channel (GCC) field. The node 11 may communicate with any other node 11 by using the GCC field.

Therefore, information such as DM measurement values and buffer delay amount described in the first embodiment may be transmitted and received among nodes 11 by using the GCC field. The communication among nodes 11 using the GCC field may be referred to, for the sake of convenience, as “GCC communication”.

The GCC communication among nodes 11 enables distribution of control, processing, and management by the OPS 12 described in the first embodiment, to nodes 11, and thereby reduces the processing load of the OPS 12.

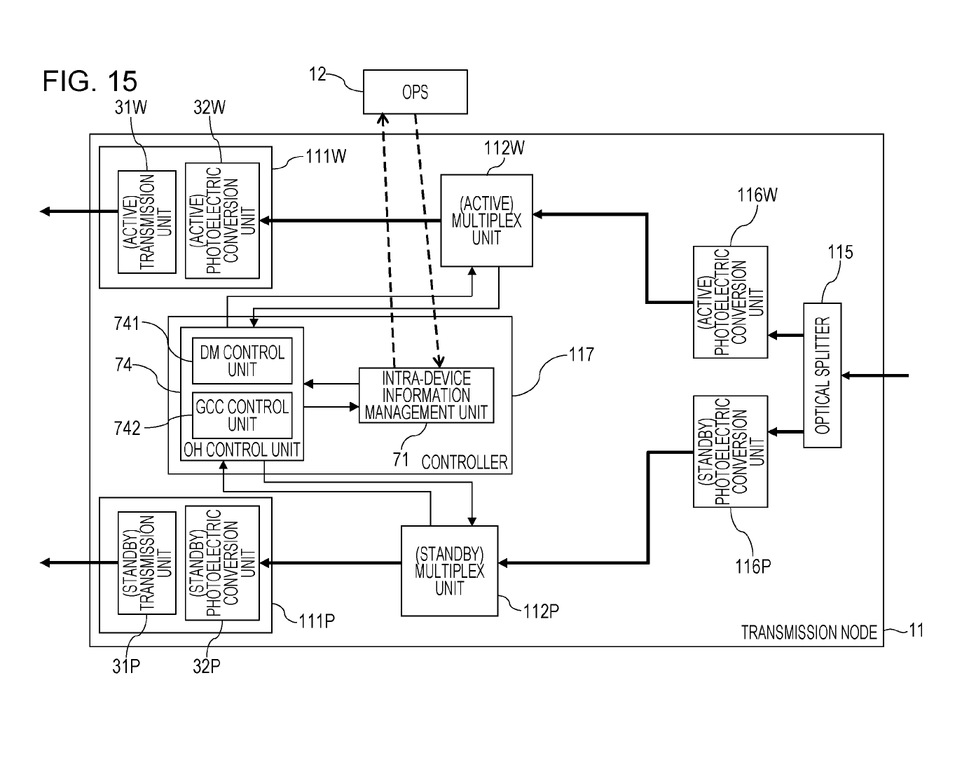

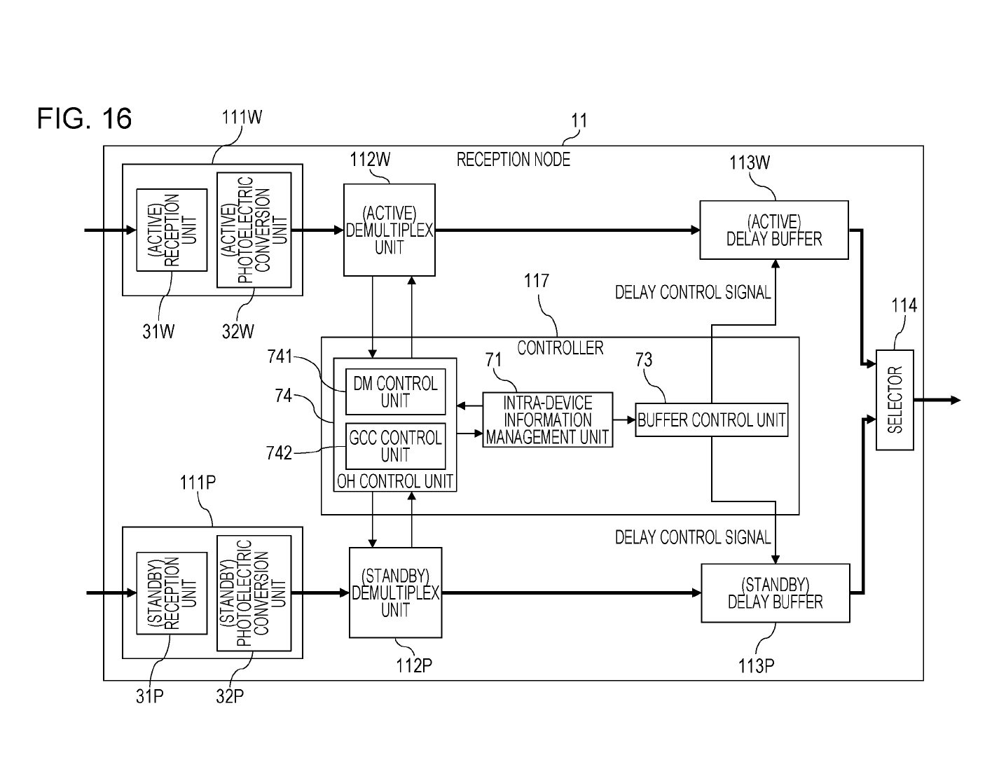

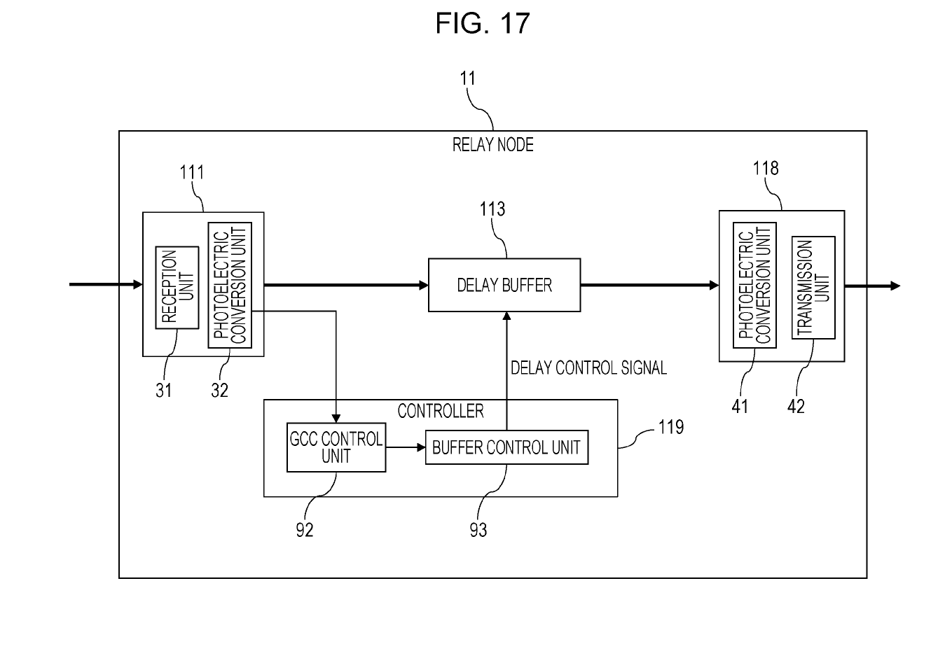

Hereinafter, the second embodiment is described by focusing on differences from the first embodiment. Configuration of the network 1 may be the same as the configuration illustrated in FIG. 1. FIG. 15 illustrates a configuration example of a transmission node 11 according to the second embodiment, and FIG. 16 illustrates a configuration example of a reception node 11 according to the second embodiment. FIG. 17 illustrates a configuration example of a relay node 11 according to the second embodiment.

The node 11 illustrated in FIG. 15 may be considered to correspond to the transmission node A illustrated in FIG. 1. The reception node 11 illustrated in FIG. 16 may be considered to correspond to the reception node E illustrated in FIG. 1. The relay node 11 illustrated in FIG. 17 may be considered to correspond to the relay nodes B and C illustrated in FIG. 1.

(Configuration Example of Transmission Node)

The configuration of the transmission node 11 illustrated in FIG. 15 corresponds to a configuration example focused on a transmission system for the active route #1 and the standby route #2. For this reason, delay buffers 113W and 113P, the buffer control unit 73, as well as the selector 114, which are illustrated in FIG. 5, are omitted in FIG. 15.

In FIG. 15, “transmission-reception units” 31W and 31P illustrated in FIG. 5 are referred to, for the sake of convenience, as “transmission units” 31W and 31P, respectively, and “multiplex-demultiplex units” 112W and 112P are referred to, for the sake of convenience, as “multiplex units” 112W and 112P, respectively.

Compared with the configuration illustrated in FIG. 5, the transmission node 11 illustrated in FIG. 15 is different in respect that the controller 117 is provided with an OH control unit 74 in place of the DM control unit 72. The OH control unit 74 includes, by way of example, a DM control unit 741 and a GCC control unit 742.

The DM control unit 741 may be provided with the same function as the DM control unit 72 of the first embodiment. For example, the DM control unit 741 implements and controls DM processing in accordance with the DM implementation instruction from the intra-device information management unit 71.

The DM measurement value obtained by the DM control unit 741 through implementation of the DM processing may be notified, for example, to the intra-device information management unit 71. The intra-device information management unit 71 does not have to notify the notified DM measurement value to the OPS 12.

Instead, the intra-device information management unit 71 may calculate the one-way delay time difference of the UPSR by arithmetic operation represented by the formula (3) of the first embodiment. Therefore, the intra-device information management unit 71 of the second embodiment may be considered to correspond to an example of the computation unit, or may be considered to be provided with the function of the computation unit.

The intra-device information management unit 71 may calculate the “delay distribution amount” borne by each of nodes 11 in the “delay distribution route”, based on the calculated one-way delay time difference. When determining the delay distribution amount, the intra-device information management unit 71 may inquire of the OPS 12 the number of relay nodes in the “delay distribution route”.

The GCC control unit 742 controls, by way of example, the GCC field of OH information added to the ODUk path signal through the signal multiplexing by the multiplex unit 112W (112P). For example, the GCC control unit 742 may set a DM measurement value obtained by the DM control unit 72 and the delay distribution amount obtained by the intra-device information management unit 71 into the GCC field.

(Configuration Example of Reception Node)

The configuration of the reception node 11 illustrated in FIG. 16 corresponds to a configuration example focused on a reception system for the active route #1 and the standby route #2. For this reason, the optical splitter 115 and photoelectric conversion units 116W and 116P, which form an example of the transmission system illustrated in FIG. 5, are omitted in FIG. 16.

In FIG. 16, “transmission-reception units” 31W and 31P illustrated in FIG. 5 are referred to, for the sake of convenience, as “receiving units” 31W and 31P, respectively, and “multiplex-demultiplex units” 112W and 112P are referred to, for the sake of convenience, as “demultiplex units” 112W and 112P, respectively.

A controller 117 illustrated in FIG. 16 may correspond to the controller 117 in the transmission node 11 illustrated in FIG. 15. In other words, the controller 117 may be shared by the transmission system and the receiving system in one node 11.

For this reason, the controller 117 illustrated in FIG. 16 may include the intra-device information management unit 71 and the OH control unit 74 (DM control unit 741 and GCC control unit 742), which are illustrated in FIG. 15, and also may include the buffer control unit 73 illustrated in FIG. 5.

(Configuration Example of Relay Node)

The relay node 11 illustrated in FIG. 17 is different from the configuration example of the relay node 11 illustrated in FIG. 6 in respect that the controller 119 is provided with a GCC control unit 92 in place of the intra-device information management unit 91.

The GCC control unit 92 may, by way of example, extract information set to the GCC field of OH information from the received electric signal obtained by the photoelectric conversion unit 32 of the optical receiver 111, and give the information to the buffer control unit 93.

For example, when information of the delay amount by the delay buffer 113 in the own node 11 calculated by another node 11 is set to the GCC field, the GCC control unit 92 extracts and gives information of the delay amount to the buffer control unit 93.

Hereinafter, operation related to the DM processing of the second embodiment is described, for the sake of convenience, by comparison with the flowchart illustrated in FIG. 9.

Steps P10 to P70 illustrated in FIG. 9 may be the same even in the second embodiment. That is, in response to the path setting request from the operator terminal 20 to the OPS 12, the OPS 12 implements the setting of active paths #1 and #2, and gives the DM implementation instruction to the transmission node A. Similarly with the first embodiment, the transmission node A implements the “two-way DM processing” or the “ring round-trip DM processing”.

The DM control unit 741 of the transmission node A obtains the DM measurement value by DM processing. In the first embodiment, the DM measurement value is notified to the OPS 12 in the step P80. In the second embodiment, the DM measurement value is notified to the intra-device information management unit 71, but not to the OPS 12.

For example, the DM control unit 741 notifies the DM measurement value DM(R) obtained by the “ring round-trip DM processing” for the active route #1, and the two-way DM measurement value DM(N) for the standby route #2, to the intra-device information management unit 71.

Based on the DM measurement value notified by the DM control unit 741, the intra-device information management unit 71 implements, in place of the OPS 12, arithmetic operation of the one-way delay time difference between the active route #1 and the standby route #2, that the OPS 12 implements in the step P90 of FIG. 9. Arithmetic operation of the delay time difference may be the same as in the first embodiment.

Based on the calculated delay time difference, the intra-device information management unit 71 implements, in place of the OPS 12, calculation of the buffer delay amount borne by each of the relay nodes B and C as well as the reception node E, which is implemented by the OPS in the step P100 of FIG. 9. When calculating the buffer delay amount, the intra-device information management unit 71 may inquire of the OPS 12 the number of relay nodes in the active route #1 and the standby route #2.

The intra-device information management unit 71 determines a route having a smaller delay time from the delay time difference between the active route #1 and the standby route #2. Then, based on the number of relay nodes in a route determined to have a smaller delay time, and the calculated delay time difference, the intra-device information management unit 71 calculates the buffer delay amount to be borne by relay nodes and the reception node in the route having a smaller delay time.

In the first embodiment, the OPS 12 notifies the calculated buffer delay amount to target nodes 11. In the second embodiment, the intra-device information management unit 71 notifies the buffer delay amount for target nodes 11 to the GCC control unit 742.

The GCC control unit 742 sets the buffer delay amount notified by the intra-device information management unit 71 into the GCC field in OH information of a signal flowing in the direction toward the target node 11. The buffer delay amount set in the GCC field is detected and extracted by the GCC control unit 92 or 742 of the target node 11. In other words, the buffer delay amount is notified to the target node 11 via GCC communication.

In accordance with the buffer delay amount notified via GCC communication, the target node 11 controls the buffer delay amount of the own node 11 in the same manner as the step P120 of FIG. 9. For example, in the reception node E, the GCC control unit 742 notifies the buffer delay amount extracted from the GCC field to the intra-device information management unit 71.

The intra-device information management unit 71 gives the buffer delay amount notified by the GCC control unit 742, to the buffer control unit 73. In accordance with information given by the intra-device information management unit 71, the buffer control unit 73 controls the delay amount of the delay buffer 113W (113P).

Meanwhile, in the relay nodes B and C, the GCC control unit 92 notifies the buffer delay amount extracted from the GCC field to the buffer control unit 93. In accordance with the buffer delay amount notified by the GCC control unit 92, the buffer control unit 93 controls the delay amount of the delay buffer 113.

With the buffer delay amount in the target node 11 adjusted in this way, “uninterruptible switching” by the selector 114 is possible in the reception node E similarly with the first embodiment.

According to the second embodiment described above, similar operation effects with the first embodiment may be obtained, and the processing load of the OPS 12 may be reduced. Therefore, for example, the failure rate of the OPS 12 may be reduced, and thereby the probability of failure in control and management of the network 1 may be reduced.

In the aforesaid second embodiment, calculation of the one-way delay time difference and calculation of the buffer delay amount based on the calculation result thereof have been described by citing an example in which both of the calculations are implemented by one node 11 (for example, transmission node A).

However, calculation of the delay time difference and calculation of the buffer delay amount may be implemented by multiple nodes 11 (which may include the OPS 12) in a distributed manner. This avoids or reduces concentration of the processing load to one node 11 (for example, transmission node A).

The node 11 and the OPS 12, which implement (perform) calculation of either or both of the delay time difference and the buffer delay amount, may be adaptively changed according to the processing load of the node 11 and the OPS 12. The adaptive change may be implemented with the GCC communication described above.

<Others>

In the aforesaid first and second embodiments, an example of measuring the one-way delay time difference, for example, in the active route #1 and the standby route #2 in the direction from the transmission node A to the reception node E in FIG. 1 is described.

However, the one-way delay time difference in the backward direction from the reception node E toward the transmission node A also may be measured in the same manner as the first and second embodiments. For example, in the aforesaid first and second embodiments, “transmission node A” may be replaced with “reception node E”, and “reception node E” may be replaced with “transmission node E”.

In the aforesaid first and second embodiments, examples of implementing the “ring round-trip DM processing” by changing OH information of a transmission signal to the active route #1, and implementing the “two-way DM processing” for the standby route #2 are described.

However, the one-way delay time difference in the direction from the transmission node A to the reception node E also may be calculated by implementing the “ring round-trip DM processing” by changing OH information of a transmission signal for the standby route #2, and implementing the “two-way DM processing” for the active route #1.

In the aforesaid first and second embodiments, examples that a route of which OH information is changed by the transmission node A for “ring round-trip DM processing” is different from a route of which OH information is changed by the transmission node A for “two-way DM processing” in “ring round-trip DM processing” are described.

However, a route for which the transmission node A changes OH information may be shared in the “ring round-trip DM processing” and the “two-way DM processing” in the “ring round-trip DM processing”.

For example, the transmission node A may change OH information corresponding to the active route #1 for “ring round-trip DM processing”, and change OH information corresponding to the same active route #1 for the “two-way DM processing” in the “ring round-trip DM processing”.

For example, the transmission node A may change each of the DMp bit and the RES bit of the “PM&TCM” field in the OH information corresponding to the active route #1 from “0” to “1”.

Alternatively, the transmission node A may change OH information corresponding to the standby route #2 for the “ring round-trip DM processing”, and change OH information corresponding to the same standby route #2 for the “two-way DM processing” in the “ring round-trip DM processing”.

For example, the transmission node A may change each of the DMp bit and the RES bit of the “PM&TCM” field in the OH information corresponding to the standby route #2 from “0” to “1”.

In other words, a signal whose DMP bit is changed in the transmission node A, and a signal whose RES bit is changed in the transmission node A may be the same. In this case, the number of signals of which OH information is changed decreases as compared with the first and second embodiments, and thereby processing for changing the OH information may be simplified.

In response to reception (detection) of a signal having the DMp bit of 1, the reception node E changes the DMp bit of a signal to be transmitted in a direction toward the transmission node A in the same route the signal was received, from “0” to “1”.

Since the RES bit of the signal having the DMp bit of 1 is set at “1”, the reception node E also changes the RES bit of a signal to be transmitted in a direction toward the transmission node A in a route different from a route from which the signal is received, from “0” to “1”.

In other words, in response to reception of a signal having the DMp bit set at 1 and the RES bit set at 1, the reception node E transmits signals in the backward direction to a route from which the signal is received, and in a direction toward the transmission node A to a route different from the route from which the signal is received.

However, in these cases, the transmission node A determines a one-way delay time difference in the direction from the reception node E to the transmission node A, which is opposite to the direction discussed in the first and second embodiments. When the one-way delay time difference in the backward direction may be considered to be equivalent to the one-way delay time difference in the forward direction, the buffer delay time may be controlled in the same manner as the first and second embodiments based on the one-way delay time difference in the backward direction.

In the aforesaid first and second embodiments, an example that routes established among the nodes A to E are two routes, #1 and #2, is described. However, three or more routes may be established between the nodes A to E. The aforesaid “ring round-trip DM processing” may be applied to two routes out of three or more routes.

Further, in the aforesaid first and second embodiments, an example that the “ring round-trip DM processing” is applied to the UPSR of the OTN that is an example of the network 1 is described. However, the “ring round-trip DM processing” may be applied, for example, to a network 1 in which multiple signal-reachable routes are able to be established between two NEs, and thereby operation effects similar to the aforesaid first and second embodiments may be achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission system in which a first route and a second route different from the first route are established between a first node and a second node, the transmission system comprising:
a measuring unit configured to measure a first signal-transmission time indicating a time that is taken for a signal to be transmitted in a route starting from the first node and returning to the first node after passing through the first route, the second node, and the second route, and a second signal-transmission time indicating a time that is taken for a signal to be transmitted in a round-trip route of one of the first and second routes; and
a computation unit configured to calculate, based on a measurement result of the measuring unit, a transmission time difference indicating a difference between transmission times of a signal transmitted through the first route and a signal transmitted through the second route in a transmission direction of the first signal.

2. The transmission system of claim 1, wherein
the first node includes a first transmission unit configured to transmit a signal to one of the first route and the second route;
the second node includes a second transmission unit configured:
to, in response to reception of a first signal from the first route, transmit a second signal to the second route in a direction toward the first node, and
to, in response to reception of a third signal from one of the first and second routes, transmit a fourth signal to the one of the first and second routes in the direction toward the first node;
the measuring unit measures, in the first node, a transmission timing of the first signal, a reception timing of the second signal, a transmission timing of the third signal, and a reception timing of the fourth signal; and
based on the measurement result, the computation unit calculates, as the transmission time difference, a reception time difference indicating a difference of reception timings of signals under a condition where the second node receives the signals from the first and second routes, respectively.

3. The transmission system of claim 2, wherein
the transmission timing of the first signal corresponds to a timing when the first transmission unit changes overhead information of the first signal corresponding to the first route,
the reception timing of the second signal corresponds to a timing when the first node detects a change in overhead information of the second signal which corresponds to the second route and whose change is made by the second transmission unit,
the transmission timing of the third signal corresponds to a timing when the first transmission unit changes overhead information of the third signal corresponding to the one of the first and second routes, and
the reception timing of the fourth signal corresponds to a timing when the first node detects a change in overhead information of the fourth signal which corresponds to the one of the first and second routes and whose change is made by the second transmission unit.

4. The transmission system of claim 2, wherein
the computation unit calculates the reception timing difference by subtracting one of a first difference between the transmission timing of the first signal and the reception timing of the second signal, and a second difference between the transmission timing of the third signal and the reception timing of the fourth signal, from the other one of the first and second differences.

5. The transmission system of claim 2, wherein
the second node includes:
a delay buffer capable of adjusting a delay time of each of signals received from the first and second routes;
a selector configured to select one of a signal received from the first route and a signal received from the second route; and
a buffer control unit configured to control the delay time to be adjusted by the delay buffer such that the reception timing difference calculated by the computation unit becomes minimum.

6. The transmission system of claim 5, wherein
at least one of the first and second routes is provided with one or more relay nodes each including a delay buffer capable of adjusting a delay time of a signal; and
the transmission system further includes a control unit configured to control the delay times adjusted by the delay buffers of the relay node and the second node such that the reception timing difference calculated by the computation unit becomes minimum.

7. A method of measuring a transmission time difference in a transmission system in which a first route and a second route different from the first route are established between a first node and a second node, the method comprising:
measuring a first signal-transmission time indicating a time that is taken for a signal to be transmitted in a route starting from the first node and returning to the first node after passing through the first route, the second node, and the second route, and a second signal-transmission time indicating a time that is taken for a signal to be transmitted in a round-trip route of one of the first and second routes; and
calculating, based on a result of the measuring, a transmission time difference indicating a difference between transmission times of a signal transmitted through the first route and a signal transmitted through the second route in a transmission direction of the first signal.

8. The method of claim 7, wherein
the measuring includes:
causing the first node to transmit a signal to any of the first route and the second route,
causing the second node to, in response to reception of a first signal from the first route, transmit a second signal to the second route in a direction toward the first node, and
causing the second node to, in response to reception of a third signal from one of the first and second routes, transmit a fourth signal to the one of the first and second routes in the direction toward the first node; and
the calculating includes:
calculating, as the transmission time difference, a reception timing difference indicating a difference of reception timings of signals under a condition where the second node receives the signals from the first and second routes, respectively, based on a transmission timing of the first signal, a reception timing of the second signal, a transmission timing of the third signal, and a reception timing of the fourth signal in the first node.

9. The method of claim 8, wherein
the transmission timing of the first signal corresponds to a timing when the first node changes overhead information of the first signal corresponding to the first route,
the reception timing of the second signal corresponds to a timing when the first node detects a change in overhead information of the second signal which corresponds to the second route and whose change is made by the second node,
the transmission timing of the third signal corresponds to a timing when the first node changes overhead information of the third signal corresponding to the one of the first and second routes, and
the reception timing of the fourth signal corresponds to a timing when the first node detects a change in overhead information of the fourth signal which corresponds to the one of the first and second routes and whose change is made by the second node.

10. The method of claim 8, wherein
the reception timing difference is calculated by subtracting one of a first difference between the transmission timing of the first signal and the reception timing of the second signal, and a second difference between the transmission timing of the third signal and the reception timing of the fourth signal, from the other one of the first and second differences.

11. A node serving as a first node in a transmission system in which a first route and a second route different from the first route are established between the first node and a second node, the node comprising:
a transmission unit configured to transmit a signal to one of the first route and the second route;
a receiving unit configured:
to receive a second signal transmitted to the second route by the second node when the second node receives a first signal transmitted to the first route, and
to receive a fourth signal transmitted to one of the first and second routes by the second node when the second node receives a third signal transmitted to the one of the first and second routes; and
a measuring unit configured to measure a transmission timing of the first signal, a reception timing of the second signal, a transmission timing of the third signal, and a reception timing of the fourth signal.

12. The node of claim 11, wherein
the transmission timing of the first signal corresponds to a timing when the transmission unit changes overhead information of the first signal corresponding to the first route,
the reception timing of the second signal corresponds to a timing when the receiving unit detects a change in overhead information of the second signal which corresponds to the second route and whose change is made by the second node,
the transmission timing of the third signal corresponds to a timing when the transmission unit changes overhead information of the third signal corresponding to the one of the first and second routes, and
the reception timing of the fourth signal corresponds to a timing when the receiving unit detects a change in overhead information of the fourth signal which corresponds to the one of the first and second routes and whose change is made by the second node.

13. The node of claim 11, further comprising:
a computation unit configured to calculate the reception timing difference by subtracting one of a first difference between the transmission timing of the first signal and the reception timing of the second signal, and a second difference between the transmission timing of the third signal and the reception timing of the fourth signal, from the other one of the first and second differences.

14. The node of claim 11, further comprising:
a notification unit configured to notify a measurement result of the measuring unit to an external control device to allow the external control device to calculate a reception timing difference between signals to be received by the second node respectively from the first and second routes.

15. A node serving as a second node in a transmission system in which a first route and a second route different from the first route are established between a first node and the second node, the node comprising:
a receiving unit configured to receive a signal that the first node transmits to one of the first route and the second route; and
a transmission unit configured:
to, in response to reception of a first signal from the first route, transmit a second signal to the second route in a direction toward the first node, and
to, in response to reception of a third signal from one of the first and second routes, transmit a fourth signal to the one of the first and second routes in the direction toward the first node.

16. The node of claim 15, wherein
in response to detection of the first signal in which overhead information corresponding to the first route is changed in the first node, the transmission unit changes overhead information, corresponding to the second route, of the second signal to be transmitted to the second route; and
in response to detection of the third signal in which overhead information corresponding to the one of the first and second routes is changed in the first node, the transmission unit changes overhead information, corresponding to the one of the first and second routes, of the fourth signal to be transmitted to the one of the first and second routes.
